(19) United States
(12) Patent Application Publication
(10) Pub. No.: US 2025/0184807 A1
(43) Pub. Date: Jun. 5, 2025

(54) LINK STATE DISCRIMINANT

(71) Applicant: QUALCOMM INCORPORATED, San Diego, CA (US)

(72) Inventors: Sandip HOMCHAUDHURI, San Jose, CA (US); Ahmed Ragab ELSHERIF, San Jose, CA (US); Aaditya RAI, Bangalore (IN); Nicholas KUCHAREWSKI, San Jose, CA (US); Srinivas KATAR, Fremont, CA (US); Xiaolong HUANG, Santee, CA (US); Harinder SINGH, Saratoga, CA (US); Douglas DAHLBY, Aldie, VA (US); John Thomas HARRSEN, San Jose, CA (US); Mughilan RAMAJAYAM, Pleasanton, CA (US); Anuradha CHANDRAMOULI, San Jose, CA (US); Anand NAGARAJAN, Chennai (IN); Shanmuganathan PALANISAMY, Chennai (IN)

(21) Appl. No.: 18/844,003

(22) PCT Filed: Apr. 12, 2023
(86) PCT No.: PCT/US2023/065679

§ 371 Date: Sep. 4, 2024

(30) Foreign Application Priority Data
Apr. 18, 2022 (IN) 202241022828

(51) Int. Cl. H04W 28/02; H04W 52/02; H04W 72/543

(52) U.S. Cl. CPC H04W 28/0221; H04W 52/0232; H04W 52/0235; H04W 72/543

(57) ABSTRACT

This disclosure provides methods, devices and systems for provisioning resources for wireless communication. Some implementations more specifically relate to provisioning resources based on link state discriminants (LSDs). In some aspects, an LSD may indicate an average amount of time a respective station (STA) is in an awake state. In such aspects, an access point (AP) may prioritize communication with specific STAs, or over specific links, based on the LSDs. In some other aspects, an LSD may indicate an average amount of time all STAs associated with an AP are in an awake state. In such aspects, the AP may dynamically reduce power consumption based on the LSDs. Still further, in some aspects, an LSD may indicate an average amount of time two or more STAs are concurrently in an awake state on a given link. In such aspects, an AP may assign STAs to multi-user groups based on the LSDs.

### CROSS REFERENCES

The present application is a 371 national stage filing of International PCT Application No. PCT/US2023/065679 by Homchaudhuri et al. entitled “LINK STATE DISCRIMINANT,” filed Apr. 12, 2023; and claims priority to Indian Patent Application No. 202241022828 by Homchaudhuri et al. entitled “LINK STATE DISCRIMINANT,” filed Apr. 18, 2022, each of which is assigned to the assignee hereof, and each of which is expressly incorporated by reference in its entirety herein.

### TECHNICAL FIELD

This disclosure relates generally to wireless communication, and more specifically, to link state discriminants in wireless communication.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

An AP provisions or otherwise allocates resources to its associated STAs for communication in a WLAN. Example resources may include time, frequency, memory, or processing resources, among other examples. Some APs rely on feedback from the network to determine resource allocations that balance the capabilities, requirements, and channel conditions of their associated STAs. For example, an AP may adjust a modulation and coding scheme (MCS) used for data transmissions to a particular STA until a packet error rate (PER) associated with the transmissions settles a desired PER (at which point the MCS will have converged to a data rate that is optimized for the desired PER). The process by which an AP controls or adjusts an allocation of resources based on feedback from the network can be referred to as a “control loop.” As wireless networks continue to grow, and wireless technologies continue to evolve, new mechanisms are needed to ensure that various control loops can converge on resource allocations that are optimized for communication between the wireless communication devices in a given network.

### SUMMARY

The systems, methods and devices of this disclosure each have several innovative aspects, no single one of which is solely responsible for the desirable attributes disclosed herein.

One innovative aspect of the subject matter described in this disclosure can be implemented as a method of wireless communication. The method may be performed by a wireless communication device, and may include receiving, via a first wireless communication link, one or more first packets carrying power management information indicating whether a first wireless station (STA) is in an awake state or a power save mode on the first wireless communication link; and provisioning one or more resources for communication with the first STA based on a first link residency metric (LRM) associated with the power management information carried in the one or more first packets and indicating an average amount of time the first STA is in the awake state on the first wireless communication link.

In some aspects, the method may further include receiving, via the first wireless communication link, one or more second packets carrying power management information indicating whether a second STA is in an awake state or a power save mode on the first wireless communication link. In some implementations, the provisioning of the one or more resources is further based on a second LRM associated with the power management information carried in the one or more second packets and indicating an average amount of time the second STA is in the awake state on the first wireless communication link. In some implementations, the provisioning of the one or more resources may include provisioning a first spatial stream to the first STA and a second spatial stream to the second STA based on each of the first LRM and the second LRM being greater than a threshold value. In some implementations, the first and second spatial streams are provisioned for concurrent communication with a multi-user (MU) multiple-input multiple-output (MIMO) group.

In some aspects, the provisioning of the one or more resources may be further based on a time coherency metric (TCM) associated with the power management information carried in the one or more first packets and the power management information carried in the one or more second packets. In some implementations, the TCM indicates an average amount of time the first STA and the second STA are concurrently in the awake state on the first wireless communication link. In some other aspects, the provisioning of the one or more resources may be further based on a basic service set (BSS) activity metric (BAM) indicating an average amount of time all STAs associated with the wireless communication device are in the awake state on the first wireless communication link.

Another innovative aspect of the subject matter described in this disclosure can be implemented in a wireless communication device. In some implementations, the wireless communication device may include at least one processor and at least one memory communicatively coupled with the at least one processor and storing processor-readable code. In some implementations, execution of the processor-readable code by the at least one processor causes the wireless communication device to perform operations including receiving, via a first wireless communication link, one or more first packets carrying power management information indicating whether a first STA is in an awake state or a power save mode on the first wireless communication link; and provisioning one or more resources for communication with the first STA based on a first LRM associated with the power management information carried in the one or more first packets and indicating an average amount of time the first STA is in the awake state on the first wireless communication link.

Another innovative aspect of the subject matter described in this disclosure can be implemented as a method of wireless communication. The method may be performed by a wireless communication device and may include receiving one or more first packets carrying power management information indicating whether a first STA is in an awake state or a power save mode; receiving one or more second packets carrying power management information indicating whether a second STA is in an awake state or a power save mode; and provisioning one or more resources for communication with the first STA and the second STA based on a TCM associated with the power management information carried in the one or more first packets and the power management information carried in the one or more second packets. In some implementations, the TCM indicates an average amount of time the first STA and the second STA are concurrently in the awake state.

In some implementations, the provisioning of the one or more resources may include provisioning a first spatial stream to the first STA and a second spatial stream to the second STA based on the TCM being greater than a threshold value. In some implementations, the first and second spatial streams are provisioned for concurrent communication with an MU-MIMO group. In some aspects, the provisioning of the one or more resources may be further based on a first LRM associated with the power management information carried in the one or more first packets and a second LRM associated with the power management information carried in the one or more second packets. In some implementations, the first LRM indicates an average amount of time the first STA is in the awake state and the second LRM indicates an average amount of time the second STA is in the awake state.

Another innovative aspect of the subject matter described in this disclosure can be implemented in a wireless communication device. In some implementations, the wireless communication device may include at least one processor and at least one memory communicatively coupled with the at least one processor and storing processor-readable code. In some implementations, execution of the processor-readable code by the at least one processor causes the wireless communication device to perform operations including receiving one or more first packets carrying power management information indicating whether a first STA is in an awake state or a power save mode; receiving one or more second packets carrying power management information indicating whether a second STA is in an awake state or a power save mode; and provisioning one or more resources for communication with the first STA and the second STA based on a TCM associated with the power management information carried in the one or more first packets and the power management information carried in the one or more second packets. In some implementations, the TCM indicates an average amount of time the first STA and the second STA are concurrently in the awake state.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 shows a pictorial diagram of an example wireless communication network.

FIG. 2A shows an example protocol data unit (PDU) usable for communication between an access point (AP) and one or more wireless stations (STAs).

FIG. 2B shows an example field in the PDU of FIG. 2A.

FIG. 3 shows an example physical layer convergence protocol (PLCP) protocol data unit (PPDU) usable for communication between an AP and one or more STAs.

FIG. 4 shows a block diagram of an example wireless communication device.

FIG. 5A shows a block diagram of an example AP.

FIG. 5B shows a block diagram of an example STA.

FIG. 6 shows a system of tiered control loops for wireless communication according to some implementations.

FIG. 7A shows a timing diagram depicting example link residency profiles of multiple STAs associated with an AP.

FIG. 7B shows another timing diagram depicting example link residency profiles of the STAs shown in FIG. 7A.

FIG. 8 shows an example basic service set (BSS) that includes an AP and multiple STAs, according to some implementations.

FIG. 9 shows an example mapping of traffic flows to service classes associated with a service level agreement (SLA), according to some implementations.

FIG. 10 shows a block diagram of an AP according to some implementations.

FIG. 11 shows an example mapping of traffic flows between frame buffers and packet queues, according to some implementations.

FIG. 12 shows a timing diagram depicting example link residency profiles of a STA multi-link device (MLD) associated with an AP MLD.

FIG. 13 shows an example communication system that includes an AP MLD and a STA MLD, according to some implementations.

FIG. 14 shows an example mesh network that includes multiple AP MLDs and a STA MLD, according to some implementations.

FIG. 15 shows a timing diagram depicting example link residency profiles of multiple STAs associated with an AP.

FIG. 16 shows a timing diagram depicting example link residency profiles of multiple STA MLDs associated with an AP MLD.

FIG. 17 shows an example communication environment with overlapping basic service sets (OBSSs), according to some implementations.

FIG. 18 shows a timing diagram depicting example link residency profiles of multiple STAs associated with an AP.

FIG. 19 shows a flowchart illustrating an example process for wireless communication that supports link state discriminants.

FIG. 20 shows a flowchart illustrating an example process for wireless communication that supports link state discriminants.

FIG. 21 shows a block diagram of an example wireless communication device according to some implementations.

FIG. 22 shows a block diagram of an example wireless communication device according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

As described above, a “control loop” is a process by which an access point (AP) adjusts an allocation of resources (such as time, frequency, memory, or processing resources) for wireless stations (STAs) associated with a basic service set (BSS) based on feedback from the network. Some STAs may enter a power save mode to conserve power (or extend battery life). While operating in the power save mode, a STA cannot transmit, receive, or listen to communication on a wireless channel. As a result, STAs entering or exiting the power save mode may affect the feedback associated with various control loops. For example, a rate selection scheme that relies on relatively slow packet error rate (PER) updates may not converge on an optimal modulation and coding scheme (MCS) for data transmissions to a particular STA that exhibits poor signal-to-noise ratio (SNR) performance and enters a power save mode before the PER associated with the transmissions can settle. Aspects of the present disclosure recognize that an AP can improve the performance of various control loops if it knows how often its associated STAs are available to transmit or receive wireless communication on a wireless channel.

As used herein, the term “link residency” refers to the availability of a STA to transmit and receive communication over a wireless communication link (or channel). More specifically, a STA is “resident” on a wireless communication link when operating in an active state (and thus able to transmit and receive wireless communication) on that particular link. By contrast, a STA is not resident on a wireless communication link when operating in a power save mode (and thus not able to transmit or receive wireless communication) on that particular link. Existing versions of the IEEE 802.11 standard describe a power management (PM) bit that can be used to indicate whether a STA is operating in an active state or a power save mode. For example, when entering a power save mode, a STA may transmit a packet (such as a null data packet (NDP)) having a PM bit set to 1. Further, when returning to an active state, the STA may transmit a packet (such as an NDP) having a PM bit set to 0. Aspects of the present disclosure recognize that an AP can monitor the link residencies of its associated STAs based on the power management information (such as a PM bit) carried in packets transmitted by the STAs.

Various aspects relate generally to techniques for provisioning resources for wireless communication, and more particularly, to provisioning resources based on link state discriminants. As used herein, the term “link state discriminant” (LSD) generally refers to metrics that can be derived by monitoring link residencies of one or more STAs associated with an AP. In some aspects, an LSD (also referred to as a link residency metric (LRM)) may indicate an average amount of time a respective STA is in the awake state on a given link. In some implementations, the AP may provision resources for communication with its associated STAs in a manner that prioritizes STAs or links associated with high LRMs. In some other implementations, the AP may provision resources for communication with its associated STAs in a manner that prioritizes STAs associated with low LRMs. In some other aspects, an LSD (also referred to as a BSS activity metric (BAM)) may indicate an average amount of time all STAs associated with the AP are in the awake state on a given link. In some implementations, the AP may deactivate or power down one or more links or wireless radios associated with low BAMs. In some other implementations, the AP may provide BAM information to one or more STAs. Still further, in some aspects, an LSD (also referred to as a time coherency metric (TCM)) may indicate an average amount of time two or more STAs are concurrently in the awake state on a given link. In some implementations, the AP may provision MU-MIMO data streams for groups of STAs associated with high TCMs.

Particular implementations of the subject matter described in this disclosure can be implemented to realize one or more of the following potential advantages. By formulating LSDs based on the link residencies of its associated STAs, an AP can configure various control loops to converge on resource allocations that are optimized for communication with each of the associated STAs. For example, aspects of the present disclosure may improve the performance of control loops associated with MU-MIMO scheduling, frame buffer allocation, data storage location, link primality detection, and mesh network steering by prioritizing some resource allocations for links or STAs associated with high LRMs. On the other hand, aspects of the present disclosure may improve the performance of control loops associated with traffic flow management by prioritizing some resource allocations for STAs associated with low LRMs. Aspects of the present disclosure also may improve the performance of control loops associated with AP power management by deactivating or powering down one or more links or wireless radios associated with low BAMs. Further, aspects of the present disclosure also may improve the performance of control loops associated with BSS load management by providing BAM information to one or more STAs. Still further, aspects of the present disclosure may improve the performance of control loops associated with MU-MIMO scheduling by provisioning MU-MIMO data streams for groups of STAs associated with high TCMs.

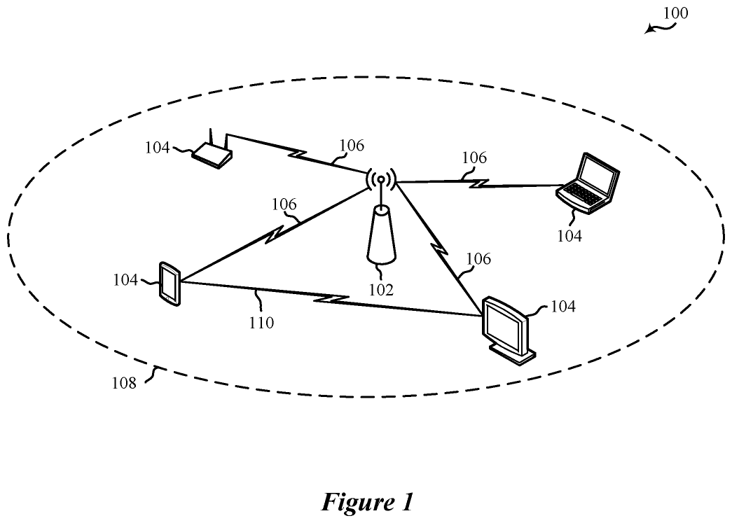

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ah, 802.11ad, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs), one TU being equal to 1024 microseconds (ρs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communication (hereinafter also referred to as “Wi-Fi communication”) to and from one another in the form of physical layer convergence protocol (PLCP) protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 700 MHz band. Some implementations of the APs 102 and STAs 104 described herein also may communicate in other frequency bands, such as the 6 GHz band, which may support both licensed and unlicensed communication. The APs 102 and STAs 104 also can be configured to communicate over other frequency bands such as shared licensed frequency bands. In some implementations, multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

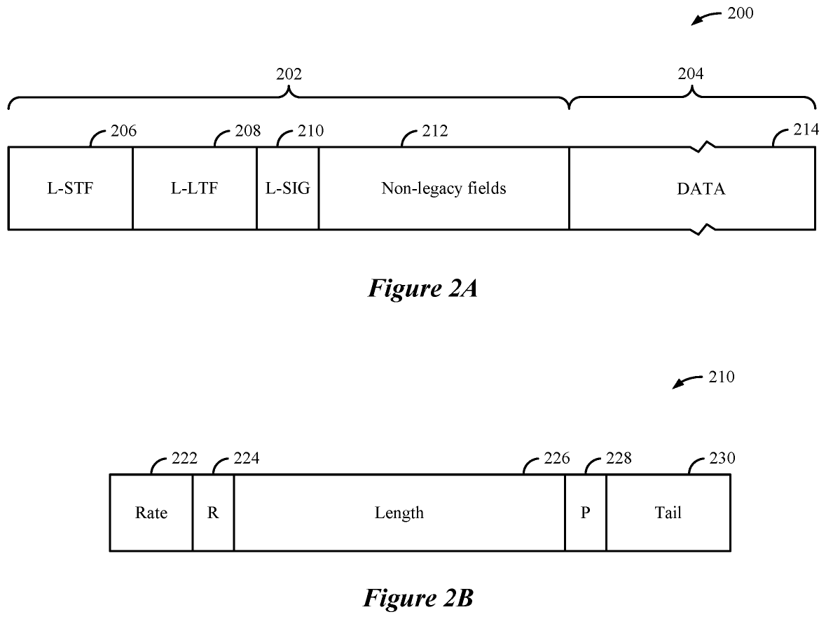

FIG. 2A shows an example protocol data unit (PDU) 200 usable for wireless communication between an AP 102 and one or more STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two BPSK symbols, a legacy long training field (L-LTF) 208, which may consist of two BPSK symbols, and a legacy signal field (L-SIG) 210, which may consist of two BPSK symbols. The legacy portion of the preamble 202 may be configured according to the IEEE 802.11a wireless communication protocol standard. The preamble 202 may also include a non-legacy portion including one or more non-legacy fields 212, for example, conforming to an IEEE wireless communication protocol such as the IEEE 802.11ac, 802.1 lax, 802.11be or later wireless communication protocol protocols.

The L-STF 206 generally enables a receiving device to perform automatic gain control (AGC) and coarse timing and frequency estimation. The L-LTF 208 generally enables a receiving device to perform fine timing and frequency estimation and also to perform an initial estimate of the wireless channel. The L-SIG 210 generally enables a receiving device to determine a duration of the PDU and to use the determined duration to avoid transmitting on top of the PDU. For example, the L-STF 206, the L-LTF 208 and the L-SIG 210 may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of medium access control (MAC) protocol data units (MPDUs) or an aggregated MPDU (A-MPDU).

FIG. 2B shows an example L-SIG 210 in the PDU 200 of FIG. 2A. The L-SIG 210 includes a data rate field 222, a reserved bit 224, a length field 226, a parity bit 228, and a tail field 230. The data rate field 222 indicates a data rate (note that the data rate indicated in the data rate field 222 may not be the actual data rate of the data carried in the payload 204). The length field 226 indicates a length of the packet in units of, for example, symbols or bytes. The parity bit 228 may be used to detect bit errors. The tail field 230 includes tail bits that may be used by the receiving device to terminate operation of a decoder (for example, a Viterbi decoder). The receiving device may utilize the data rate and the length indicated in the data rate field 222 and the length field 226 to determine a duration of the packet in units of, for example, microseconds (μs) or other time units.

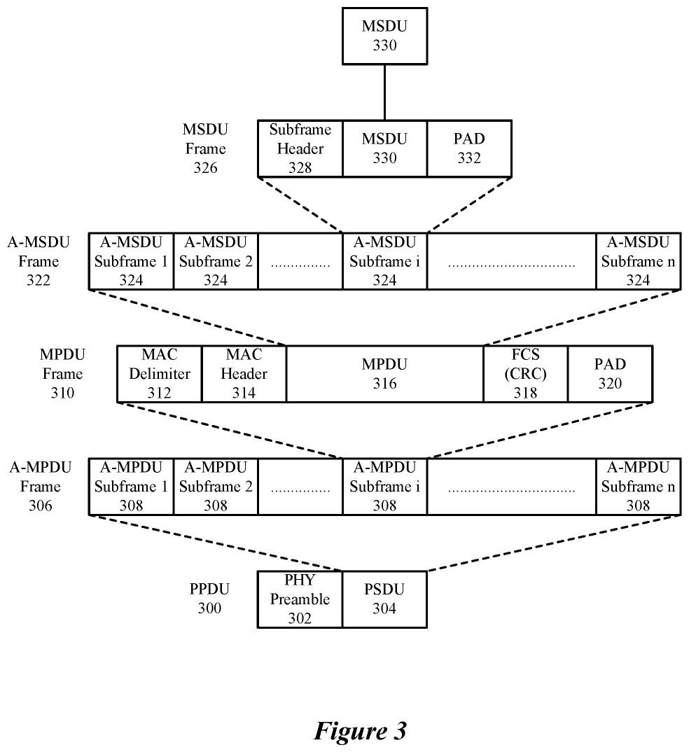

FIG. 3 shows an example PPDU 300 usable for communication between an AP 102 and one or more STAs 104. As described above, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which comprises the data portion (“payload” or “frame body”) of the MPDU frame 310. Each MPDU frame 310 may also include a frame check sequence (FCS) field 318 for error detection (for example, the FCS field may include a cyclic redundancy check (CRC)) and padding bits 320. The MPDU 316 may carry one or more MAC service data units (MSDUs) 326. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the MPDU 316 (such as within the frame body). The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the MPDU 316 (such as within the frame body). For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

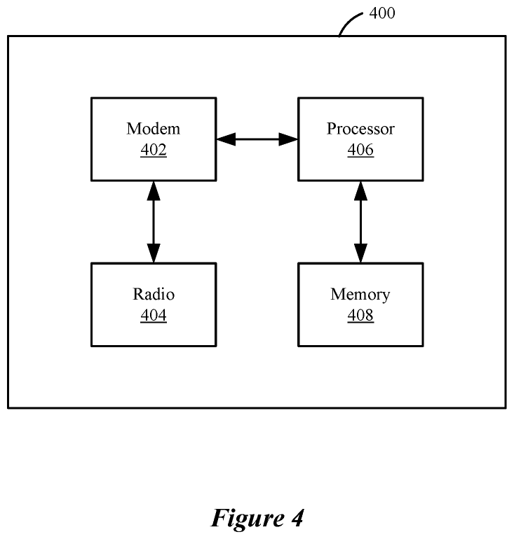

FIG. 4 shows a block diagram of an example wireless communication device 400. In some implementations, the wireless communication device 400 can be an example of a device for use in a STA such as one of the STAs 104 described with reference to FIG. 1. In some implementations, the wireless communication device 400 can be an example of a device for use in an AP such as the AP 102 described with reference to FIG. 1. The wireless communication device 400 is capable of transmitting (or outputting for transmission) and receiving wireless communication (for example, in the form of wireless packets). For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 400 can be, or can include, a chip, system on chip (SoC), chipset, package or device that includes one or more modems 402, for example, a Wi-Fi (IEEE 802.11 compliant) modem. In some implementations, the one or more modems 402 (collectively “the modem 402”) additionally include a WWAN modem (for example, a 3GPP 4G LTE or 5G compliant modem). In some implementations, the wireless communication device 400 also includes one or more radios 404 (collectively “the radio 404”). In some implementations, the wireless communication device 400 further includes one or more processors, processing blocks or processing elements 406 (collectively “the processor 406”) and one or more memory blocks or elements 408 (collectively “the memory 408”).

The modem 402 can include an intelligent hardware block or device such as, for example, an application-specific integrated circuit (ASIC) among other possibilities. The modem 402 is generally configured to implement a PHY layer. For example, the modem 402 is configured to modulate packets and to output the modulated packets to the radio 404 for transmission over the wireless medium. The modem 402 is similarly configured to obtain modulated packets received by the radio 404 and to demodulate the packets to provide demodulated packets. In addition to a modulator and a demodulator, the modem 402 may further include digital signal processing (DSP) circuitry, automatic gain control (AGC), a coder, a decoder, a multiplexer and a demultiplexer. For example, while in a transmission mode, data obtained from the processor 406 is provided to a coder, which encodes the data to provide encoded bits. The encoded bits are then mapped to points in a modulation constellation (using a selected MCS) to provide modulated symbols. The modulated symbols may then be mapped to a number N_{SS} of spatial streams or a number N_{STS} of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and ultimately, the radio 404. In implementations involving beamforming, the modulated symbols in the respective spatial streams are precoded via a steering matrix prior to their provision to the IFFT block.

While in a reception mode, digital signals received from the radio 404 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 406) for processing, evaluation or interpretation.

The radio 404 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 400 can include, or be coupled with, multiple transmit antennas (each with a corresponding transmit chain) and multiple receive antennas (each with a corresponding receive chain). The symbols output from the modem 402 are provided to the radio 404, which then transmits the symbols via the coupled antennas. Similarly, symbols received via the antennas are obtained by the radio 404, which then provides the symbols to the modem 402.

The processor 406 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 406 processes information received through the radio 404 and the modem 402, and processes information to be output through the modem 402 and the radio 404 for transmission through the wireless medium. For example, the processor 406 may implement a control plane and MAC layer configured to perform various operations related to the generation and transmission of MPDUs, frames or packets. The MAC layer is configured to perform or facilitate the coding and decoding of frames, spatial multiplexing, space-time block coding (STBC), beamforming, and OFDMA resource allocation, among other operations or techniques. In some implementations, the processor 406 may generally control the modem 402 to cause the modem to perform various operations described above.

The memory 408 can include tangible storage media such as random-access memory (RAM) or read-only memory (ROM), or combinations thereof. The memory 408 also can store non-transitory processor- or computer-executable software (SW) code containing instructions that, when executed by the processor 406, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more components of one or more computer programs.

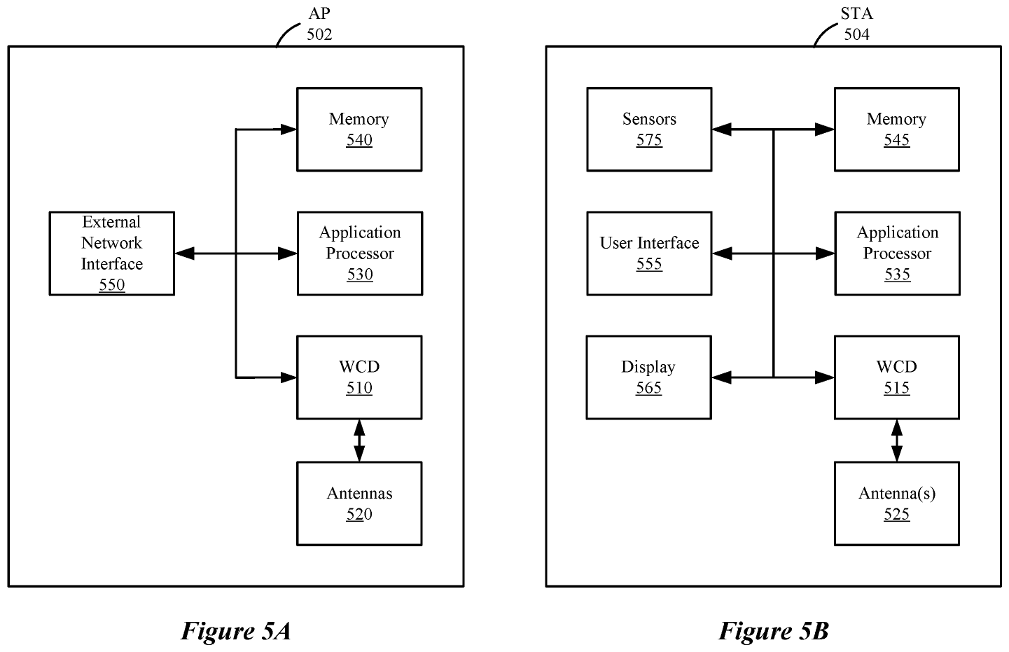

FIG. 5A shows a block diagram of an example AP 502. For example, the AP 502 can be an example implementation of the AP 102 described with reference to FIG. 1. The AP 502 includes a wireless communication device 510 (although the AP 502 may itself also be referred to generally as a wireless communication device as used herein). For example, the wireless communication device 510 may be an example implementation of the wireless communication device 400 described with reference to FIG. 4. The AP 502 also includes multiple antennas 520 coupled with the wireless communication device 510 to transmit and receive wireless communication. In some implementations, the AP 502 additionally includes an application processor 530 coupled with the wireless communication device 510, and a memory 540 coupled with the application processor 530. The AP 502 further includes at least one external network interface 550 that enables the AP 502 to communicate with a core network or backhaul network to gain access to external networks including the Internet. For example, the external network interface 550 may include one or both of a wired (for example, Ethernet) network interface and a wireless network interface (such as a WWAN interface). Ones of the aforementioned components can communicate with other ones of the components directly or indirectly, over at least one bus. The AP 502 further includes a housing that encompasses the wireless communication device 510, the application processor 530, the memory 540, and at least portions of the antennas 520 and external network interface 550.

FIG. 5B shows a block diagram of an example STA 504. For example, the STA 504 can be an example implementation of the STA 104 described with reference to FIG. 1. The STA 504 includes a wireless communication device 515 (although the STA 504 may itself also be referred to generally as a wireless communication device as used herein). For example, the wireless communication device 515 may be an example implementation of the wireless communication device 400 described with reference to FIG. 4. The STA 504 also includes one or more antennas 525 coupled with the wireless communication device 515 to transmit and receive wireless communication. The STA 504 additionally includes an application processor 535 coupled with the wireless communication device 515, and a memory 545 coupled with the application processor 535. In some implementations, the STA 504 further includes a user interface (UI) 555 (such as a touchscreen or keypad) and a display 565, which may be integrated with the UI 555 to form a touchscreen display. In some implementations, the STA 504 may further include one or more sensors 575 such as, for example, one or more inertial sensors, accelerometers, temperature sensors, pressure sensors, or altitude sensors. Ones of the aforementioned components can communicate with other ones of the components directly or indirectly, over at least one bus. The STA 504 further includes a housing that encompasses the wireless communication device 515, the application processor 535, the memory 545, and at least portions of the antennas 525, UI 555, and display 565.

As described above, a “control loop” is a process by which an AP adjusts an allocation of resources (such as time, frequency, memory, or processing resources) for STAs associated with a BSS based on feedback from the network. Some STAs may enter or exit a power save mode, which may affect the feedback associated with various control loops. As used herein, the term “link residency” refers to the availability of a STA to transmit and receive communication over a wireless communication link (or channel). Existing versions of the IEEE 802.11 standard describe a PM bit that can be used to indicate whether a STA is operating in an active state or a power save mode. For example, when entering a power save mode, a STA may transmit a packet (such as an NDP) having a PM bit set to 1. Further, when returning to an active state, the STA may transmit a packet (such as an NDP) having a PM bit set to 0. Aspects of the present disclosure recognize that an AP can monitor the link residencies of its associated STAs based on the power management information (such as a PM bit) carried in packets transmitted by the STAs.

Various aspects relate generally to techniques for provisioning resources for wireless communication, and more particularly, to provisioning resources based on link state discriminants. As used herein, the term “link state discriminant” (LSD) generally refers to metrics that can be derived by monitoring link residencies of one or more STAs associated with an AP. In some aspects, an LSD (also referred to as a link residency metric (LRM)) may indicate an average amount of time a respective STA is in the awake state on a given link. In some implementations, the AP may provision resources for communication with its associated STAs in a manner that prioritizes STAs or links associated with high LRMs. In some other implementations, the AP may provision resources for communication with its associated STAs in a manner that prioritizes STAs associated with low LRMs. In some other aspects, an LSD (also referred to as a BSS activity metric (BAM)) may indicate an average amount of time all STAs associated with the AP are in the awake state on a given link. In some implementations, the AP may deactivate or power down one or more links or wireless radios associated with low BAMs. In some other implementations, the AP may provide BAM information to one or more STAs. Still further, in some aspects, an LSD (also referred to as a time coherency metric (TCM)) may indicate an average amount of time two or more STAs are concurrently in the awake state on a given link. In some implementations, the AP may provision MU-MIMO data streams for groups of STAs associated with high TCMs.

Particular implementations of the subject matter described in this disclosure can be implemented to realize one or more of the following potential advantages. By formulating LSDs based on the link residencies of its associated STAs, an AP can configure various control loops to converge on resource allocations that are optimized for communication with each of the associated STAs. For example, aspects of the present disclosure may improve the performance of control loops associated with MU-MIMO scheduling, frame buffer allocation, data storage location, link primality detection, and mesh network steering by prioritizing some resource allocations for links or STAs associated with high LRMs. On the other hand, aspects of the present disclosure may improve the performance of control loops associated with traffic flow management by prioritizing some resource allocations for STAs associated with low LRMs. Aspects of the present disclosure also may improve the performance of control loops associated with AP power management by deactivating or powering down one or more links or wireless radios associated with low BAMs. Further, aspects of the present disclosure also may improve the performance of control loops associated with BSS load management by providing BAM information to one or more STAs. Still further, aspects of the present disclosure may improve the performance of control loops associated with MU-MIMO scheduling by provisioning MU-MIMO data streams for groups of STAs associated with high TCMs.

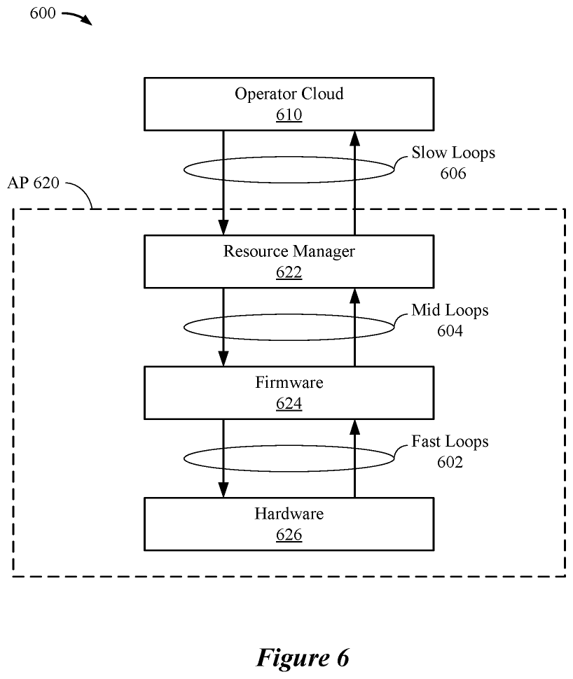

FIG. 6 shows a system 600 of tiered control loops for wireless communication according to some implementations. The example system 600 includes an operator cloud 610 and an AP 620. In some implementations, the AP 620 may be one example of any of the APs 102 or 502 of FIGS. 1 and 5A, respectively. The operator cloud 610 represents a backhaul network communicatively coupled to the AP 620 via an external network interface such as, for example, the external network interface 550 of FIG. 5A. In some implementations, the operator cloud 610 may include a network controller or any combination of hardware or software configured to control or manage various operations of the AP 620.

The AP 620 is shown to include a resource manager 622, a firmware 624 (such as one or more firmware components), and a hardware 626 (such as one or more hardware components). The firmware 624 and hardware 626 represent various components of a wireless communication device such as, for example, any of the wireless communication devices 400 or 510 of FIGS. 4 and 5A, respectively. With reference for example to FIG. 4, the hardware 626 may include one or more components of the modem 402 or the radio 404, and the firmware 624 may include one or more components of the processor 406 or the memory 408 configured to implement various PHY and MAC layer functionality associated with wireless communication. The resource manager 622 represents software executed by a host processor such as, for example, the application processor 530 of FIG. 5A. With reference for example to FIG. 5A, the resource manager 622 may include instructions stored in memory 540 that can be executed by the application processor 530 to control various operations of the wireless communication device 510 (including the firmware 624 and hardware 626).

In some aspects, the system 600 may provide hierarchical levels of control for various aspects of wireless communication by the AP 620. In some implementations, the firmware 624 may implement one or more “fast” control loops 602 based on feedback from the hardware 626. The fast control loops 602 may control various resource allocation decisions associated with (such as that require) fast convergence. Examples of fast control loops 602 may include just-in-time scheduling, smart enhanced distributed channel access (EDCA) adjustments, lazy or aggressive rate control, MU-MIMO or OFDMA grouping, and pausing or unpausing of traffic identifiers (TIDs), among other examples. For example, when implementing a fast control loop 602 associated with MU-MIMO operation, the firmware 624 may instruct the hardware 626 to concurrently communicate with multiple STAs (not shown for simplicity), as an MU-MIMO group, based on feedback from the STAs in response to a channel sounding operation. More specifically, the firmware 624 may assign the STAs to the MU-MIMO group upon (such as in accordance with) determining that the STAs are associated with uncorrelated channels. Thus, the fast control loops 602 may adapt to instantaneous changes in the wireless communication environment.

In some implementations, the resource manager 622 may implement one or more “mid” control loops 604 based on feedback from the firmware 624. The mid control loops 604 may control various resource allocation decisions with slower convergence requirements than those associated with the fast control loops 602. Examples of mid control loops 604 may include multi-link operation (MLO) link provisioning, activating or deactivating multi-link device (MLD) links, enabling or disabling MU communication, enabling or disabling fast rate control, configuring rate control loop constants, configuring maximum data rates, enabling or disabling energy-efficient operation, and configuring uplink (UL) or downlink (DL) throttling limits, among other examples. For example, when implementing a mid control loop 604 associated with MU-MIMO operation, the resource manager 622 may instruct the firmware 624 to suspend or resume MU-MIMO communication with a group of STAs based on feedback associated with one or more STAs in the group. In some aspects, the decision to suspend or resume MU-MIMO communication may be based on one or more LSDs associated with a link residency of each STA in the group. Thus, the mid control loops 604 may provide a dynamic range of execution for the fast control loops 602.

In some implementations, the operator cloud 610 may implement one or more “slow” control loops 606 based on feedback from the resource manager 622. The slow control loops 606 may control various resource allocation decisions with even slower convergence requirements than those associated with the mid control loops 604. Examples of slow control loops 606 may include setting thresholds for obtaining or otherwise determining one or more LSDs, setting link congestion thresholds and peer reliability thresholds for provisioned MLO, and configuring parameters for managed MU staging, among other examples. For example, when implementing a slow control loop 606 associated with MU-MIMO operation, the operator cloud 610 may provide, to the resource manager 622, one or more boundary conditions for suspending or resuming MU-MIMO communication with any group of STAs. In some aspects, such boundary conditions may include one or more LSD thresholds, whereby the resource manager 622 can enable MU-MIMO communication with a group of STAs only if one or more LSDs associated with the group of STAs exceed the one or more LSD thresholds. Thus, the slow control loops 606 may manage one or more decision thresholds for the mid control loops 604.

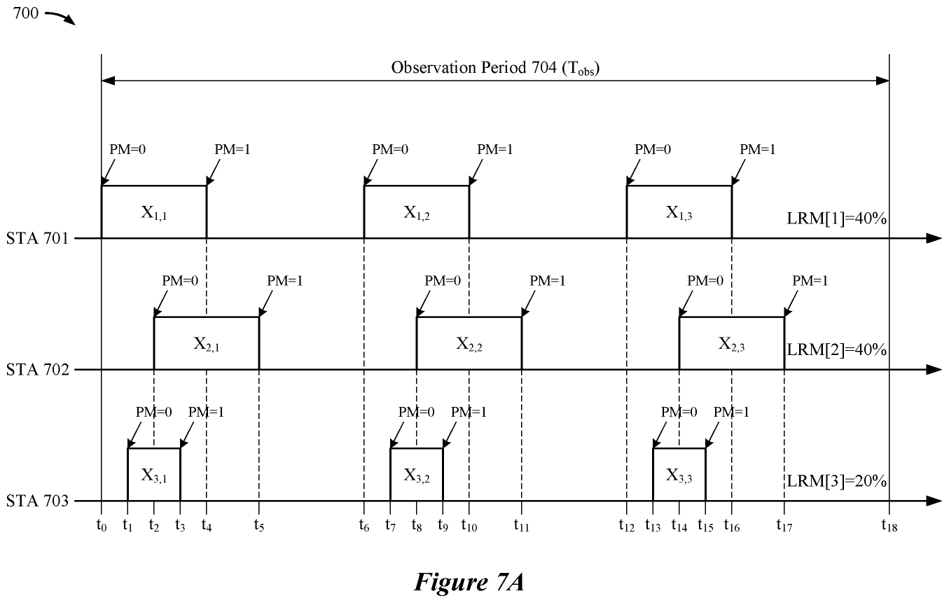

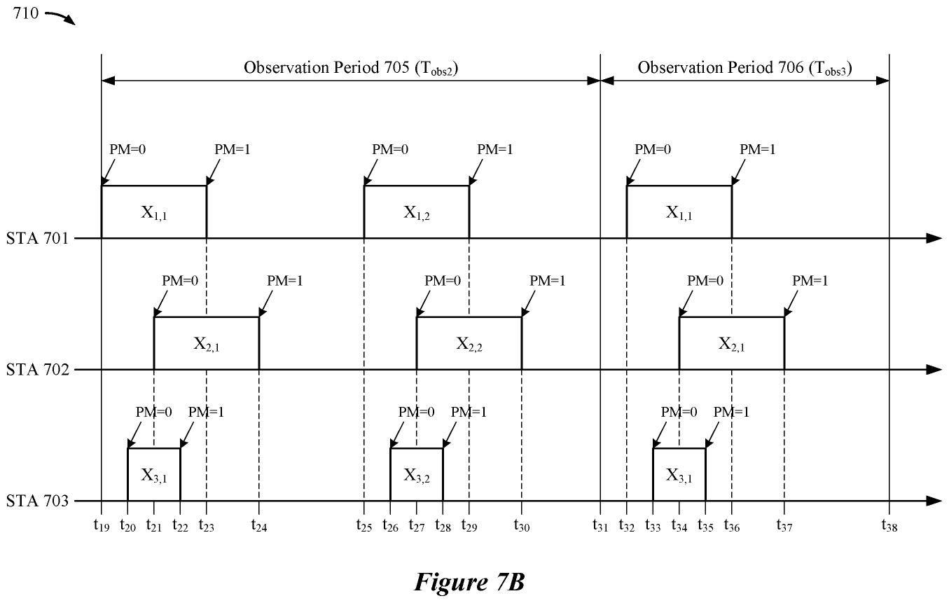

FIG. 7A shows a timing diagram 700 depicting example link residency profiles of multiple STAs 701-703 associated with an AP. In some implementations, the AP may be one example of any of the APs 102, 502, or 620 of FIGS. 1, 5A, and 6, respectively. In some implementations, each of the STAs 701-703 may be one example of any of the STAs 104 or 504 of FIGS. 1 and 5B, respectively. For simplicity, three STAs 701-703 are shown in FIG. 7A. However, in some other implementations, the AP may be associated with fewer or more STAs than those depicted in FIG. 7A.

In some aspects, the AP may observe or monitor a residency of each of the STAs 701-703 on a particular wireless communication link or channel. More specifically, the AP may measure a duration of each interval (X) that a STA is resident on the link based on power management information carried in one or more packets received from the STA. Aspects of the present disclosure recognize that each link residency interval X may be bounded by a first packet (such as an NDP) having a PM bit set to 1 and a second packet (such as an NDP) having a PM bit set to 0. Thus, the AP may measure the duration of the link residency interval X as the elapsed time between the first packet (having a PM bit set to 1) and the second packet (having a PM bit set to 0).

In some implementations, the AP may calculate (such as determine) or otherwise derive a respective link residency metric (LRM) for each of the STAs 701-703 based on a number (N) of link residency intervals (Xᵢⱼ) measured over the duration (T_{obs}) of an observation period 704, between times t₀ and t₉. In some implementations, LRM[i] represents the LRM for the i^{th} STA:

$$L R M [ i ] = {\sum }_{j = 1}^{N} \frac{{X}_{i , j}}{{T}_{o b s}} \qquad ( 1 )$$

Thus, LRM[i] indicates an average amount of time the i^{th} STA is in the awake state on a given link. In the example of FIG. 7A, the STAs 701, 702, and 703 are assigned to indexes i=1, 2, and 3, respectively. Accordingly, LRM[1] represents an LRM associated with the STA 701, LRM[2] represents an LRM associated with the STA 702, and LRM[3] represents an LRM associated with the STA 703.

The STA 701 transmits, at time t₀, a packet having a PM bit set to 0, and further transmits, at time t₄, a packet having a PM bit set to 1. Thus, the AP may measure a first link residency interval X_{1,1} as the duration between times t₀ and t₄. The STA 701 transmits, at time t₆, another packet having a PM bit set to 0, and further transmits, at time t₁₀, another packet having a PM bit set to 1. Thus, the AP may measure a second link residency interval X_{1,2} as the duration between times t₆ and t₁₀. The STA 701 transmits, at time t₁₂, another packet having a PM bit set to 0, and further transmits, at time t₁₆, another packet having a PM bit set to 1. Thus, the AP may measure a third link residency interval X_{1,3} as the duration between times t₁₂ and t₁₆. After summing X_{1,1}, X_{1,2}, and X_{1,3} and dividing the sum by T_{obs}, the AP may determine that the STA 701 is resident on the link 40% of the observation period 704 (LRM[1]=40%).

The STA 702 transmits, at time t₂, a packet having a PM bit set to 0, and further transmits, at time t₅, a packet having a PM bit set to 1. Thus, the AP may measure a first link residency interval X_{2,1} as the duration between times t₂ and t₅. The STA 702 transmits, at time t₈, another packet having a PM bit set to 0, and further transmits, at time t₁₁, another packet having a PM bit set to 1. Thus, the AP may measure a second link residency interval X_{2,2} as the duration between times t₈ and t₁₁. The STA 702 transmits, at time t₁₄, another packet having a PM bit set to 0, and further transmits, at time t₁₇, another packet having a PM bit set to 1. Thus, the AP may measure a third link residency interval X_{2,3} as the duration between times t₁₄ and t₁₇. After summing X_{2,1}, X_{2,2}, and X_{2,3} and dividing the sum by T_{obs}, the AP may determine that the STA 702 is resident on the link 40% of the observation period 704 (LRM[2]=40%).

The STA 703 transmits, at time t₁, a packet having a PM bit set to 0, and further transmits, at time t₃, a packet having a PM bit set to 1. Thus, the AP may measure a first link residency interval X_{3,1} as the duration between times t₁ and t₃. The STA 703 transmits, at time t₇, another packet having a PM bit set to 0, and further transmits, at time t₉, another packet having a PM bit set to 1. Thus, the AP may measure a second link residency interval X_{3,2} as the duration between times t₇ and t₉. The STA 703 transmits, at time t₁₃, another packet having a PM bit set to 0, and further transmits, at time tis, another packet having a PM bit set to 1. Thus, the AP may measure a third link residency interval X_{3,3} as the duration between times t₁₃ and t₁₅. After summing X_{3,1}, X_{3,2}, and X_{3,3} and dividing the sum by T_{obs}, the AP may determine that the STA 703 is resident on the link 20% of the observation period 704 (LRM[3]=20%).

Aspects of the present disclose recognize that a STA's residency profile may vary or change over time, for example, based on changes in the STA's traffic patterns. Thus, in some implementations, the AP may maintain a moving average of the LRMs associated with each of the STAs 701-703 across multiple observation periods. For example, the moving average (LRM_{avg}[i]) can be calculated (such as determined) as a function of LRM[i], the prior moving average (LRM_{avg}⁰[i]) at the time of acquiring LRM[i], and a weighting factor (α):

$$L R {M}_{avg} [ i ] = α * LRM [ i ] + ( 1 - a ) {LRM}_{a v g}^{0} [ i ] \qquad ( 2 )$$

In some implementations, the AP may dither or otherwise vary the durations of the observation periods, for example, to prevent the moving averages from falling into a beat pattern with the variations in a STA's residency profile. In other words, some observation periods may be longer or shorter than the duration of the observation period 704.

FIG. 7B shows another timing diagram 710 depicting example link residency profiles of the STAs 701-703 shown in FIG. 7A. More specifically, FIG. 7B shows two consecutive observation periods 705 and 706 immediately following the observation period 704 of FIG. 7A. For example, as shown in FIG. 7B, the observation period 705 spans a duration (T_{obs2}) from times t₁₉ to t₃₁ and the observation period 706 spans a duration (T_{obs3}) from times t₃₁ to t₃₈.

The STA 701 transmits, at time t₁₉, a packet having a PM bit set to 0, and further transmits, at time t₂₃, a packet having a PM bit set to 1. Thus, the AP may measure a first link residency interval X_{1,1}, within the observation period 705, as the duration between times t₁₉ and t₂₃. The STA 701 transmits, at time t₂₅, another packet having a PM bit set to 0, and further transmits, at time t₂₉, another packet having a PM bit set to 1. Thus, the AP may measure a second link residency interval X_{1,2}, within the observation period 705, as the duration between times t₂₅ and t₂₉. After summing X_{1,1} and X_{1,2} and dividing the sum by T_{obs2}, the AP may determine that the STA 701 is resident on the link 42% of the observation period 705 (LRM[1]=42%). The STA 701 transmits, at time t₃₂, another packet having a PM bit set to 0, and further transmits, at time t₃₆, another packet having a PM bit set to 1. Thus, the AP may measure a link residency interval X_{1,1}, within the observation period 706, as the duration between times t₃₂ and t₃₆. After dividing X_{1,1} by T_{obs3}, the AP may determine that the STA 701 is resident on the link 36% of the observation period 706 (LRM[1]=36%).

The STA 702 transmits, at time t₂₁, a packet having a PM bit set to 0, and further transmits, at time t₂₄, a packet having a PM bit set to 1. Thus, the AP may measure a first link residency interval X_{2,1}, within the observation period 705, as the duration between times t₂₁ and t₂₄. The STA 702 transmits, at time t₂₇, another packet having a PM bit set to 0, and further transmits, at time t₃₀, another packet having a PM bit set to 1. Thus, the AP may measure a second link residency interval X_{2,2}, within the observation period 705, as the duration between times t₂₇ and t₃₀. After summing X_{2,1} and X_{2,2} and dividing the sum by T_{obs2}, the AP may determine that the STA 702 is resident on the link 42% of the observation period 705 (LRM[2]=42%). The STA 702 transmits, at time t₃₄, another packet having a PM bit set to 0, and further transmits, at time t₃₇, another packet having a PM bit set to 1. Thus, the AP may measure a link residency interval X_{2,1}, within the observation period 706, as the duration between times t₃₄ and t₃₇. After dividing X_{2,1} by T_{obs3}, the AP may determine that the STA 702 is resident on the link 36% of the observation period 706 (LRM[2]=36%).

The STA 703 transmits, at time t₂₀, a packet having a PM bit set to 0, and further transmits, at time t₂₂, a packet having a PM bit set to 1. Thus, the AP may measure a first link residency interval X_{3,1}, within the observation period 705, as the duration between times t₂₀ and t₂₂. The STA 703 transmits, at time t₂₆, another packet having a PM bit set to 0, and further transmits, at time t₂₈, another packet having a PM bit set to 1. Thus, the AP may measure a second link residency interval X_{3,2}, within the observation period 705, as the duration between times t₂₆ and t₂₈. After summing X_{3,1} and X_{3,2} and dividing the sum by T_{obs2}, the AP may determine that the STA 703 is resident on the link 21% of the observation period 705 (LRM[3]=21%). The STA 703 transmits, at time t₃₃, another packet having a PM bit set to 0, and further transmits, at time t₃₅, another packet having a PM bit set to 1. Thus, the AP may measure a link residency interval X_{3,1}, within the observation period 706, as the duration between times t₃₃ and t₃₅. After dividing X_{3,1} by T_{obs3}, the AP may determine that the STA 703 is resident on the link 18% of the observation period 706 (LRM[3]=18%).

Aspects of the present disclosure recognize that per-STA LRMs can be used to improve the performance of one or more control loops. With reference for example to FIG. 6, the LRMs may be calculated (such as determined) or observed by the resource manager 622. More specifically, the resource manager 622 may use the LRMs to configure or adjust one or more mid control loops 604. For example, by knowing how often each of the STAs 701-703 is resident on a given link, the resource manager 622 can provision resources for wireless communication with the STAs 701-703 in a manner that improves the efficiency of the network. In some implementations, the resource manager 622 may prioritize some resources for STAs that are more resident on a given link (such as STAs associated with higher LRM values). In some other implementations, the resource manager 622 may prioritize some resource for STAs that are less resident on a given link (such as STAs associated with lower LRM values).

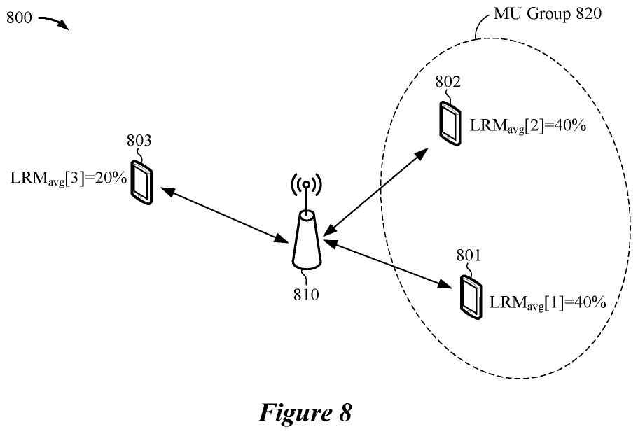

FIG. 8 shows an example BSS 800 that includes an AP 810 and multiple STAs 801-803, according to some implementations. In some implementations, the AP 810 may be one example of any of the APs 102, 502, or 620 of FIGS. 1, 5A, and 6, respectively. In some implementations, each of the STAs 801-803 may be one example of any of the STAs 104 or 504 of FIGS. 1 and 5B, respectively. In the example of FIG. 8, each the STAs 801-803 is shown to operate on the same wireless channel (or wireless communication link of the AP 810). For example, the STAs 801-803 may be example implementations of the STAs 701-703, respectively, of FIGS. 7A and 7B.

In some aspects, the AP 810 and each of the STAs 801-803 may support MU-MIMO or OFDMA communication. MU-MIMO and OFDMA (collectively referred to as “MU communication”) are wireless communication techniques that allow an AP to transmit DL data to multiple STAs, concurrently, in an MU group. More specifically, for MU-MIMO communication, the AP 810 provisions a respective spatial stream for each STA in the MU group. Each spatial stream is transmitted, using beamforming, in the direction of a respective STA. Thus, the STAs belonging to an MU-MIMO group can communicate over separate wireless channels but must be spatially separated. In contrast, for OFDMA communication, the AP 810 provisions a respective resource unit (RU), or set of RUs, for each STA in the MU group. Each RU represents a respective subset of orthogonal subcarriers associated with a wireless channel. Thus, the STAs belonging to an OFDMA group can be collocated but must share a wireless channel.

Aspects of the present disclosure recognize that the efficiency of MU communication may depend on the selection of STAs to participate in an MU group. For example, STAs that are rarely available for wireless communication on a given wireless communication link or channel may be poor candidates for MU communication. Further, grouping STAs with substantially different availabilities into the same MU group may significantly reduce the efficiency of MU communication with that MU group. For example, if a given STA in an MU group is available for wireless communication only half as often as other STAs in the MU group, the net throughput and traffic latency of DL transmissions to the other STAs will be limited by the availability of the given STA as a result of MU communication with the MU group.

In some aspects, an AP may determine whether to group its associated STAs into one or more MU groups based on one or more LRMs associated with each of the STAs. In some implementations, the AP may not consider a STA for MU grouping on a particular wireless communication link if the LRM (or average LRM) associated with the STA for that particular link is less than an LRM threshold. In some implementations, the LRM threshold may be set or specified by an operator cloud (such as the operator cloud 610 of FIG. 6). In some other implementations, the AP may assign two or more STAs to an MU group on a particular wireless communication link only if the LRMs (or average LRMs) associated with the STAs for that particular link are with a threshold range of one another. In some implementations, the threshold range may be set or specified by an operator cloud (such as the operator cloud 610 of FIG. 6).

In the example of FIG. 8, the LRM threshold for a STA to be considered for MU grouping may be set at 30%. As shown in FIG. 8, the STAs 801 and 802 are resident on the channel 40% of the time (LRM_{avg}[1]=LRM_{avg}[2]=40%). However, the STA 803 is resident on the channel only 20% of the time (LRM_{avg}[3]=20%). Because LRM_{avg}[3] is less than the LRM threshold to be considered for MU grouping, the AP 810 may not assign the STA 803 to any MU group. On the other hand, LRM_{avg}[1] and LRM_{avg}[2] are equal to one another and are each greater than the LRM threshold. Thus, the AP 810 may assign the STAs 801 and 802 to an MU group 820 provided other MU selection criteria are met (such as the STAs 801 and 802 being associated with uncorrelated wireless channels, as required for MU-MIMO communication).

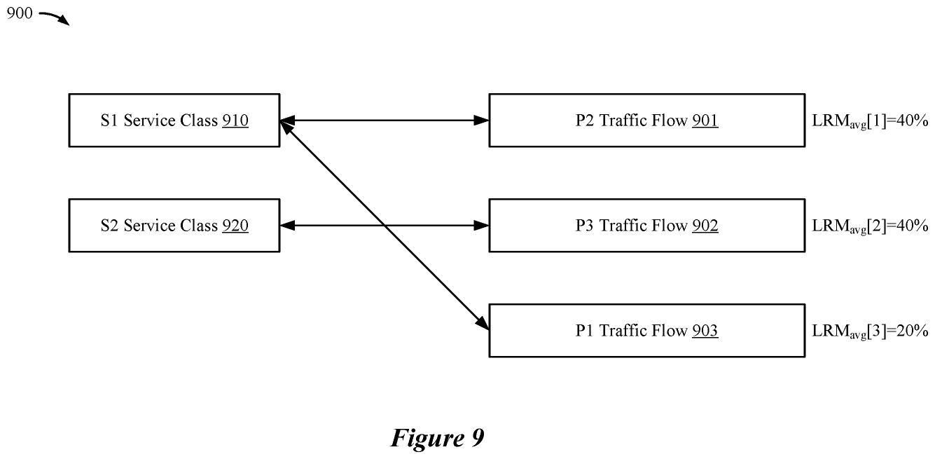

FIG. 9 shows an example mapping 900 of traffic flows 901-903 to service classes 910 and 920 associated with an SLA, according to some implementations. In some implementations, the mapping 900 may be performed by an AP, such as any of the APs 102, 502, or 620 of FIGS. 1, 5A, and 6, respectively. In some implementations, each of the traffic flows 901-903 may be associated with a respective STA, such as any of the STAs 104 or 504 of FIGS. 1 and 5B, respectively. For example, the traffic flows 901-903 may be associated with the STAs 701-703, respectively, of FIGS. 7A and 7B.

An SLA is an agreement between a service provider (such as an ISP) and a client that specifies various responsibilities of each party (such as data rate, quality of service (QoS), availability of services, and payment for services, among other examples). More specifically, an SLA may specify a class of services to be provided by the service provider to a particular client. The service class generally defines how data traffic is prioritized for the client or STA. For example, data traffic associated with higher service classes may be prioritized over data traffic associated with lower service classes. Accordingly, STAs associated with higher service classes may receive a greater number of scheduling grants (for example, to transmit or receive data over a shared wireless medium) than STAs associated with lower service classes.

According to existing wireless communication standards, traffic flows mapped to the same service class are prioritized equally. However, aspects of the present disclosure recognize that such equal prioritization of traffic flows can cause some STAs to receive significantly fewer scheduling grants than other STAs associated with the same service class. For example, among the STAs associated with the same service class, some of the STAs may be available for wireless communication less often than others. When the wireless network is congested, equally prioritizing data traffic for all STAs associated with the same service class may cause data to be dropped at a higher rate for the STAs that are available less frequently than for the STAs that are available more frequently. As a result, the service provider may fail to satisfy one or more conditions (such as data rate, QoS, or availability of services) under its SLA with a given client.

In some aspects, an AP may assign more granular priorities to the traffic flows associated with various STAs based on one or more LRMs associated with the STAs. More specifically, the AP may assign different priorities to traffic flows that are mapped to the same SLA service but are associated with different LRMs (or average LRMs). As described above, an AP has fewer opportunities to serve STAs with low link residencies, and thus has fewer opportunities to meet the conditions of an SLA associated with such STAs. Thus, in some implementations, the AP may assign higher priorities to traffic flows associated with lower LRM values (such as less than an LRM threshold) than to other traffic flows that are mapped to the same SLA service class but associated with higher LRM values (such as greater than or equal to the LRM threshold). In some implementations, the LRM threshold(s) associated with different traffic flow priorities may be set or specified by an operator cloud (such as the operator cloud 610 of FIG. 6).

In the example of FIG. 9, an LRM threshold for traffic flows to be assigned a higher or lower priority may be set at 30%. As shown in FIG. 9, the traffic flows 901 and 903 are mapped to the first service class 910, and the traffic flow 902 is mapped to the second service class 920. In the example of FIG. 9, the first service class 910 has a high service class priority (S1) whereas the second service class 920 has a low service class priority (S2). Accordingly, the traffic flow 902 may be assigned to a lower traffic flow priority (P3) than either of the remaining traffic flows 901 and 903. Among the traffic flows mapped to the first service class 910, the average LRM associated with the traffic flow 903 (LRM_{avg}[3]=20%) is less than the LRM threshold, whereas the average LRM associated with the traffic flow 901 (LRM_{avg}[1]=40%) is greater than the LRM threshold. Thus, the AP may assign the traffic flow 903 to the highest traffic flow priority (P1) among the traffic flows 901-903 and may assign the traffic flow 901 to the second-highest traffic flow priority (P2) among the traffic flows 901-903.

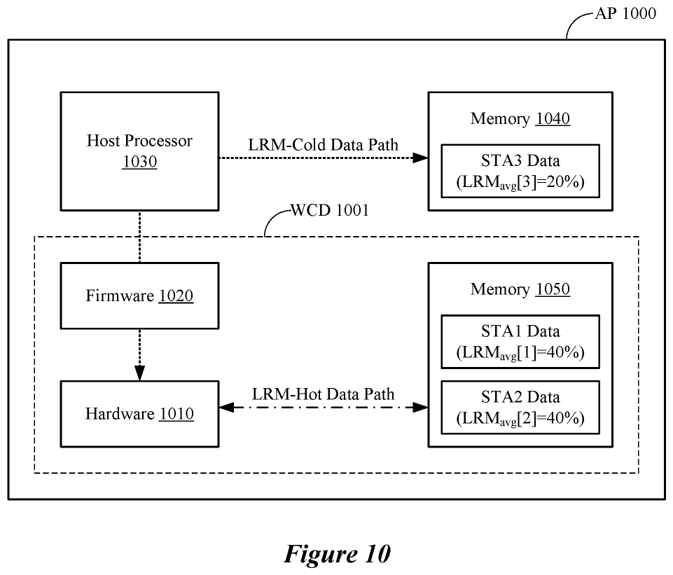

FIG. 10 shows a block diagram of an AP 1000 according to some implementations. In some implementations, the AP 1000 may be one example of any of the APs 102, 502, or 620 of FIGS. 1, 5A, and 6, respectively. As shown in FIG. 10, the AP 1000 may store or buffer data for transmission to a number of wireless stations STA1-STA3. In some implementations, each of the wireless stations may be one example of any of the STAs 104 or 504 of FIGS. 1 and 5B, respectively. For example, the wireless stations STA1-STA3 may be example implementations of the STAs 701-703, respectively, of FIGS. 7A and 7B.

The AP 1000 is shown to include a hardware 1010 (such as one or more hardware components), a firmware 1020 (such as one or more firmware components), a host processor 1030, and memories 1040 and 1050. With reference for example to FIG. 5A, the host processor 1030 and the memory 1040 may be example implementations of the application processor 530 and the memory 540, respectively. In some implementations, the hardware 1010, firmware 1020, and memory 1050 may be disposed on a wireless communication device 1001, such as any of the wireless communication devices 400 or 510 of FIGS. 4 and 5A, respectively. The wireless communication device 1001 may be a system-on-a-chip (SoC) that implements the PHY and MAC layers of the AP 1000. Thus, the memory 1050 also may be referred to herein as “on-chip” memory and the memory 1040 also may be referred to herein as “off-chip” memory. In some implementations, the on-chip memory 1050 may be a static random-access memory (SRAM). In some implementations, the off-chip memory 1040 may be a double data rate (DDR) synchronous dynamic random-access memory (SDRAM).

In the example of FIG. 10, each of the memories 1040 and 1050 can buffer data for transmission to one or more of the wireless stations STA1-STA3. With reference for example to FIG. 4, the hardware 1010 may include one or more components of the modem 402 or the radio 404. The firmware 1020 serves as an interface between the hardware 1010 and the host processor 1030. In existing APs, data associated with the wireless stations STA1-STA3 may be randomly stored in either the on-chip memory 1050 or the off-chip memory 1040. However, as shown in FIG. 10, the hardware 1010 has direct access to any data stored in the on-chip memory 1040. By contrast, the hardware 1010 must interface with the firmware 1020 and the host processor 1030 to access data stored in the off-chip memory 1040. Thus, data stored in the off-chip memory 1040 may be experience greater latencies or delays in transmission than data stored in the on-chip memory 1050.

In some aspects, the AP 1000 may determine whether to buffer the data for a particular STA in the on-chip memory 1050 or the off-chip memory 1040 based on one or more LRMs associated with the STA. Aspects of the present disclosure recognize that STAs associated with higher LRMs (or average LRMs) may have lower latency requirements than STAs associated with lower LRMs (or average LRMs). In some implementations, the AP 1000 may store, in the on-chip memory 1050, data intended for STAs associated with LRMs greater than or equal to an LRM threshold and may store, in the off-chip memory 1040, data intended for STAs associated with LRMs less than the LRM threshold. Accordingly, the data path between the hardware 1010 and the off-chip memory 1040 may be referred to as an “LRM-cold” data path, whereas the data path between the hardware 1010 and the on-chip memory 1050 may be referred to as an “LRM-hot” data path. In some implementations, the LRM threshold(s) associated with the on-chip memory 1050 or the off-chip memory 1040 may be set or specified by an operator cloud (such as the operator cloud 610 of FIG. 6).

In the example of FIG. 10, the LRM threshold for storing data in either the on-chip memory 1050 or the off-chip memory 1040 may be set at 30%. In other words, a STA associated with an LRM greater than or equal to 30% will have its data stored in the on-chip memory 1050, whereas a STA associated with an LRM less than 30% will have its data stored in the off-chip memory 1040. As shown in FIG. 10, the wireless stations STA1 and STA2 are associated with average LRMs that are greater than the LRM threshold (LRM_{avg}[1]=LRM_{avg}[2]=40%), whereas STA3 is associated with an average LRM that is less than the LRM threshold (LRM_{avg}[3]=20%). As such, the AP 1000 may store any data associated with STA1 or STA2 in the on-chip memory 1050 and may store any data associated with STA3 in the off-chip memory 1040.

Aspects of the present disclosure recognize that the LRMs associated with any given STA can change over time. In some implementations, the AP 1000 may move data between the on-chip memory 1050 and the off-chip memory 1040 in response to changes in the LRMs (or average LRMs) associated with one or more STAs. For example, if the average LRM associated with STA1 falls below the LRM threshold, the AP 1000 may move the data associated with STA1 form the on-chip memory 1050 to the off-chip memory 1040. Similarly, if the average LRM associated with STA3 rises above the LRM threshold, the AP 1000 may move the data associated with STA3 from the off-chip memory 1040 to the on-chip memory 1050.

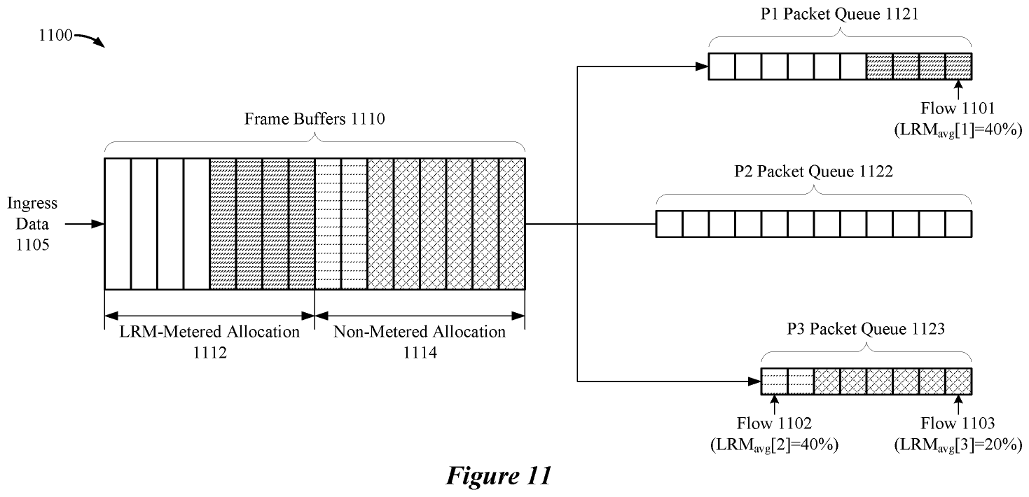

FIG. 11 shows an example mapping 1100 of traffic flows 1101-1103 between frame buffers 1110 and packet queues 1121-1123, according to some implementations. In some implementations, the mapping 1100 may be performed by an AP, such as any of the APs 102, 502, or 620 of FIGS. 1, 5A, and 6, respectively. In some implementations, each of the traffic flows 1101-1103 may be associated with a respective STA, such as any of the STAs 104 or 504 of FIGS. 1 and 5B, respectively. For example, the traffic flows 1101-1103 may be associated with the STAs 701-703, respectively, of FIGS. 7A and 7B.

The packet queues 1121-1123 are data structures that reside within a wireless communication device, such as any of the wireless communication device 400 or 510 of FIGS. 4 and 5A, respectively. More specifically, the packet queues 1121-1123 may reside in on-chip memory, such as the memory 408 of FIG. 4. By contrast, the frame buffers 1110 may reside in off-chip memory, such as the memory 540 of FIG. 5A. In some aspects, each of the frame buffers 1110 may be a respective socket buffer (skb). With reference for example to FIG. 5A, the application processor 530 may attach a respective one of the frame buffers 1110 to each frame of ingress data 1105 received by the AP (such as via the external network interface 550). Each frame of ingress data 1105 is further copied, from the frame buffers 1110, to a respective one of the packet queues 1121-1123 for transmission to a STA. Upon receiving an acknowledgement (ACK) message from a STA indicating successful receipt of a data frame, the AP removes each copy of the data frame from the frame buffers 1110 and from the packet queues 1121-1123.

Existing APs allocate frame buffers 1110 for ingress data 1105 on a first-come first-served basis. However, if a STA is not available to receive wireless communication, or otherwise does not transmit an ACK, the AP must retain copies of the STA's data in the frame buffers 1110 and in the packet queues 1121-1123. When the frame buffers 1110 become full (such that there are no more available frame buffers 1110 to allocate), the AP must drop any new ingress data 1105. Accordingly, some STAs may experience high latencies in communicating with the AP due to the low link residencies of some other STAs associated with the AP. Aspects of the present disclosure recognize that some STAs with lower link residencies may have lower priority data traffic, whereas some STAs with higher link residencies may have higher priority data traffic. In such instances, the AP may be forced to discard higher priority data traffic due to the frame buffers 1110 being full of lower priority data traffic.

In some aspects, an AP may selectively allocate one or more frame buffers 1110 for storing ingress data 1105 intended for various STAs based on one or more LRMs associated with the STAs. In some implementations, the AP may partition the allocable frame buffers 1110 into an LRM-metered allocation 1112 and a non-metered allocation 1114. Frame buffers 1110 associated with the non-metered allocation 1114 can be attached to any ingress data 1105, on a first-come first-served basis. By contrast, frame buffers 1110 associated with the LRM-metered allocation 1112 are reserved for ingress data 1105 associated with LRMs (or average LRMs) greater than or equal to one or more LRM thresholds. For example, the AP may attach ingress data 1105 to the frame buffers 1110 associated with the LRM-metered allocation 1112 only when all the frame buffers 1110 associated with the non-metered allocation 1114 are full. In some implementations, a greater number of frame buffers 1110 may be reserved for higher LRM thresholds than for lower LRM thresholds. Further, in some implementations, the LRM threshold(s) associated with the LRM-metered allocation 1112 may be set or specified by an operator cloud (such as the operator cloud 610 of FIG. 6).

In the example of FIG. 11, an LRM threshold for ingress data 1105 to be attached to frame buffers 1110 associated with the LRM-metered allocation 1112 may be set at 30%. In other words, a STA associated with an LRM greater than or equal to 30% may have its ingress data 1105 attached to one or more of the frame buffers 1110 associated with the LRM-metered allocation 1112, whereas a STA associated with an LRM less than 30% will have its ingress data dropped, once all the frame buffers 1110 associated with the non-metered allocation 1114 are full. The traffic flows 1101 and 1102 are associated with average LRMs that are greater than the LRM threshold (LRM_{avg}[1]=LRM_{avg}[2]=40%), whereas the traffic flow 1103 is associated with an average LRM that is less than the LRM threshold (LRM_{avg}[3]=20%). As shown in FIG. 11, the frame buffers 1110 associated with the non-metered allocation 1114 are full of data associated with the traffic flows 1102 and 1103. As a result, ingress data 1105 associated with the traffic flow 1101 is subsequently attached to the frame buffers 1110 associated with the LRM-metered allocation 1112.

Aspects of the present disclosure further recognize that some of the packet queues 1121-1123 may have substantially more headroom (or space to store new data) than others at any given time. Thus, in some aspects, an AP may remap one or more of the traffic flows 1101-1103 to a new packet queue if its current packet queue becomes full (or exceeds a threshold fill level). When remapping a particular traffic flow, the AP may consider the LRMs associated with the traffic flow being remapped and other data traffic stored in each of the packet queues 1121-1123. In some implementations, the AP may only remap a traffic flow to a packet queue that stores data associated with LRMs less than or equal to the LRM associated with the traffic flow being remapped (or is empty). For example, because the packet queue 1123 is full, the AP may remap the traffic flow 1102 to the packet queue 1121 (which does not store any data associated with LRMs greater than 40%) or the packet queue 1122 (which is empty).

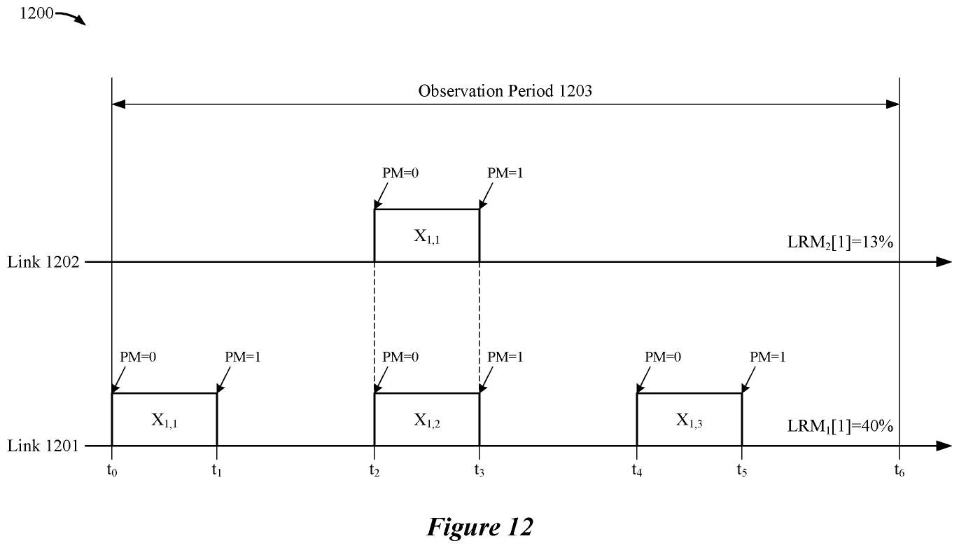

FIG. 12 shows a timing diagram 1200 depicting example link residency profiles of a STA MLD associated with an AP MLD. In some implementations, the AP MLD may be one example of any of the APs 102, 502, or 620 of FIGS. 1, 5A, and 6, respectively. In some implementations, the STA MLD may be one example of any of the STAs 104 or 504 of FIGS. 1 and 5B, respectively. In the example of FIG. 12, the STA MLD is shown to communicate with the AP MLD over a pair of communication links 1201 and 1202. However, in some other implementations, the STA MLD may communicate with the AP MLD over any number of communication links.

Wireless communication devices that are capable of multi-link operation (MLO) are referred to as multi-link devices (MLDs). An AP MLD may include multiple APs each configured to communicate on a respective communication link with a STA MLD (also referred to as a “non-AP MLD”). Similarly, the STA MLD may include multiple STAs each configured to communicate on a respective one of the communication links with the AP MLD. Some STA MLDs may communicate with the AP MLD concurrently on each of the communication links, for example, in accordance with a multi-link multi-radio (MLMR) simultaneous transmit and receive (STR) or MLMR non-STR (NSTR) mode of operation. On the other hand, some STA MLDs may communicate with the AP MLD on only one of the communication links at any given time, for example, in accordance with a multi-link single-radio (MLSR) or enhanced MLSR (EMLSR) mode of operation. Still further, some STA MLDs may communicate with the AP MLD on a subset (such as two or more) of the communication links at any given time, for example, in accordance with an enhanced MLMR (EMLMR) or hybrid EMLSR mode of operation.

In some aspects, the AP MLD may observe or monitor a residency of the STA MLD on each of the communication links 1201 and 1202. More specifically, the AP MLD may measure a duration of each interval (X) that the STA MLD is resident on each of the links 1201 and 1202 based on power management information carried in one or more packets received from the STA MLD. For example, the AP MLD may measure the duration of each link residency interval X as the elapsed time between the reception of a first packet (such as an NDP) having a PM bit set to 1 and the reception of a second packet (such as a subsequent NDP) having a PM bit set to 0.

In some implementations, the AP MLD may calculate (such as determine) or otherwise derive a respective LRM for the STA MLD on each of the links 1201 and 1202 based on a number (N) of link residency intervals (Xᵢⱼ) measured over the duration (T_{obs}) of an observation period 1203, between times t₀ and t₆. In some implementations, LRMₖ[i] represents the LRM for the i^{th} STA operating on the k^{th} communication link:

$${LRM}_{k} [ i ] = {\sum }_{j = 1}^{N} \frac{{X}_{i , j}}{{T}_{o b s}} \qquad ( 3 )$$

Thus, LRMₖ[i] indicates an average amount of time the i^{th} STA is in the awake state on the k^{th} communication link. In the example of FIG. 12, the STA MLD is assigned to index i=1. Thus, LRM₁[1] represents an LRM associated with the STA MLD on the link 1201 and LRM₂[1] represents an LRM associated with the STA MLD on the link 1202.

The STA MLD transmits, at time t₀, a packet having a PM bit set to 0 on the link 1201, and further transmits, at time t₁, a packet having a PM bit set to 1 on the link 1201. Thus, the AP MLD may measure a first link residency interval X_{1,1} on the link 1201 as the duration between times t₀ and t₁. The STA MLD transmits, at time t₂, a respective packet having a PM bit set to 0 on each of the links 1201 and 1202, and further transmits, at time t₃, a respective packet having a PM bit set to 1 on each of the links 1201 and 1202. Thus, the AP MLD may measure a second link residency interval X_{1,2} on the link 1201 as the duration between times t₂ and t₃. The AP MLD also may measure a link residency interval X_{1,1} on the link 1202 as the duration between times t₂ and t₃. The STA MLD transmits, at time t₄, a packet having a PM bit set to 0 on the link 1201, and further transmits, at time t₅, another packet having a PM bit set to 1 on the link 1201. Thus, the AP MLD may measure a third link residency interval X_{1,3} on the link 1201 as the duration between times t₄ and t₅.

After summing X_{1,1}, X_{1,2}, and X_{1,3} as measured on the link 1201 and dividing the sum by T_{obs}, the AP MLD may determine that the STA MLD is resident on the link 1201 40% of the observation period 1203 (LRM₁[1]=40%). Similarly, after dividing X_{1,1} as measured on the link 1202 by T_{obs}, the AP MLD may determine that the STA MLD is resident on the link 1202 only 13% of the observation period 1203 (LRM₂[1]=13%). In some implementations, the AP MLD may maintain a moving average of the LRMs on each of the links 1201 and 1202 across multiple observation periods. For example, a respective moving average (LRM_{avg}[i]) can be calculated (such as determined) for each of the links 1201 and 1202 according to Equation 2 (such as described with reference to FIG. 7A). In some implementations, the AP MLD may dither or otherwise vary the durations of the observation periods, for example, to prevent the moving averages from falling into a beat pattern with the variations in a STA's residency profile (such as described with reference to FIG. 7B).

Aspects of the present disclosure recognize that per-link LRMs can be used to improve the performance of one or more control loops. With reference for example to FIG. 6, the LRMs may be calculated (such as determined) or observed by the resource manager 622. More specifically, the resource manager 622 may use the LRMs to configure or adjust one or more mid control loops 604. For example, by knowing how often the STA MLD is resident on each of the links 1201 and 1202, the resource manager 622 can provision resources for wireless communication with the STA MLD in a manner that improves the efficiency of the network. In some implementations, the resource manager 622 may prioritize communication over links on which the STA MLD is more resident (such as links associated with higher LRM values). In some other implementations, the resource manager 622 may give less weight to communication over links on which the STA MLD is less resident (such as links associated with lower LRM values).

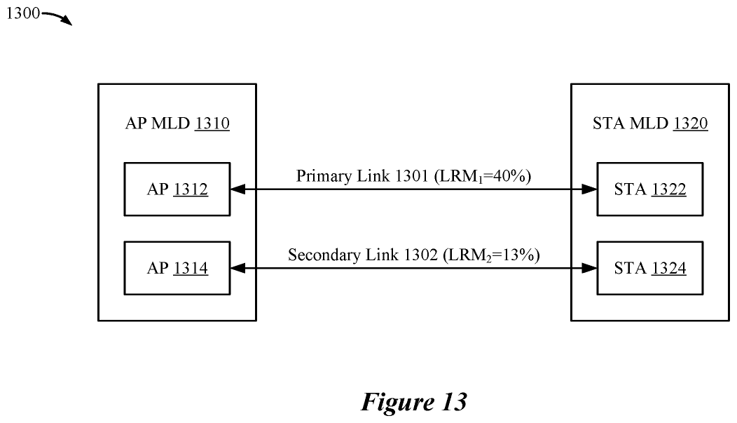

FIG. 13 shows an example communication system 1300 that includes an AP MLD 1310 and a STA MLD 1320, according to some implementations. In some implementations, the AP MLD 1310 may be one example of any of the APs 102, 502, or 620 of FIGS. 1, 5A, and 6, respectively. In some implementations, the STA MLD 1320 may be one example of any of the STAs 104 or 504 of FIGS. 1 and 5B, respectively. In the example of FIG. 13, the AP MLD 1310 and the STA MLD 1320 are shown to communicate via multiple communication links 1301 and 1302. For example, the communication links 1301 and 1302 may be example implementations of the communication links 1201 and 1202, respectively, of FIG. 12.

The AP MLD 1310 includes multiple APs 1312 and 1314 associated with (or operating on) the communication links 1301 and 1302, respectively. In the example of FIG. 13, the AP MLD 1310 is shown to include only 3 APs. However, in some other implementations, the AP MLD 1310 may include more APs than those depicted in FIG. 13. Although the APs 1312 and 1314 may share a common association context (through the AP MLD 1310), each of the APs 1312 and 1314 may establish a respective BSS on its associated communication link. The APs 1312 and 1314 also may establish their respective communication links 1301 and 1302 on different frequency bands. For example, the AP 1312 may operate on the 2.4 GHz frequency band and the AP 1314 may operate on the 5 GHz frequency band.

The STA MLD 1320 includes multiple STAs 1322 and 1324 that may be configured to communicate on the communication links 1301 and 1302, respectively. For example, the STA 1322 may operate on the 2.4 GHz frequency band and the STA 1324 may operate on the 5 GHz frequency band. In the example of FIG. 13, the STA MLD 1320 is shown to include only 2 STAs. However, in some other implementations, the STA MLD 1320 may include more STAs than those depicted in FIG. 13. Existing versions of the IEEE 802.11 standard define several modes in which the STA MLD may operate 1320. The various operating modes depend on the number of wireless radios associated with the STA MLD 1320 and its ability to communicate (such as by transmitting or receiving) concurrently on multiple communication links.

MLO significantly increases the bandwidth available for communication between the AP MLD 1310 and the STA MLD 1320. However, the STA MLD 1320 often may not require such large amounts of bandwidth. As a result, the STA MLD 1320 may utilize one or more of the communication links more frequently than others. For example, the AP MLD 1310 may communicate with the STA MLD 1320 primarily over one of the communication links 1301 or 1302 (referred to herein as the “primary link”) and may utilize the other link (referred to herein as the “secondary link”) in an opportunistic manner. More specifically, the AP MLD 1310 and the STA MLD 1320 may communicate over the secondary link only when the primary link is unavailable (such as due to interference on the wireless channel) or when additional bandwidth is needed (such as to meet higher throughput or lower latency requirements). Aspects of the present disclosure recognize that, for scheduling purposes, it is desirable for the AP MLD 1310 to know which of the communication links 1301 or 1302 is favored by the STA MLD 1320. However, existing versions of the IEEE 802.11 standard do not distinguish between a primary link and a secondary link.

In some aspects, the AP MLD 1310 may detect the primary link with the STA MLD 1320 based on one or more LRMs associated with each of the communication links 1301 and 1302. More specifically, the primary link may be associated with the highest LRM among the communication links between the AP MLD 1310 and the STA MLD 1320. In some implementations, the AP MLD 1310 may identify a communication link as the primary link if the LRM (or average LRM) associated with the communication link is greater than or equal to an LRM threshold and may identify a communication link as a secondary link if the LRM (or average LRM) associated with the communication link is less than the LRM threshold. In some implementations, the LRM threshold may be set or specified by an operator cloud (such as the operator cloud 610 of FIG. 6).

In the example of FIG. 13, the LRM threshold separating the primary link from the secondary link may be set at 30%. In other words, any communication link associated with an LRM greater than or equal to 30% will be designated the primary link and any communication link associated with an LRM less than 30% will be designated the secondary link. As shown in FIG. 13, the average LRM associated with the communication link 1301 (LRM₁=40%) is greater than the LRM threshold, whereas the average LRM associated with the communication link 1302 (LRM₂=13%) is less than the LRM threshold. As such, the AP MLD 1310 may designate the wireless communication link 1301 as the primary link and may designate the wireless communication link 1302 as the secondary link.

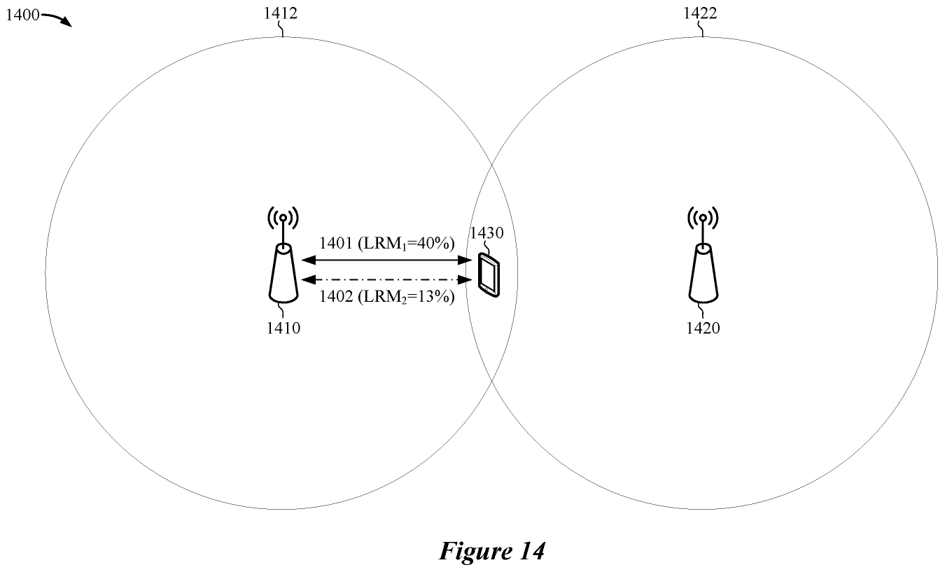

FIG. 14 shows an example mesh network 1400 that includes multiple AP MLDs 1410 and 1420 and a STA MLD 1430, according to some implementations. The AP MLD 1410 has a coverage area 1412 and the AP MLD 1420 has a coverage area 1422 that overlaps the coverage area 1412. In some implementations, each of the AP MLDs 1410 and 1420 may be one example of any of the APs 102, 502, or 620 of FIGS. 1, 5A, and 6, respectively. In some implementations, the STA MLD 1430 may be one example of any of the STAs 104 or 504 of FIGS. 1 and 5B, respectively. In the example of FIG. 14, the STA MLD 1430 is associated with the AP MLD 1410 and is configured to communicate with the AP MLD 1410 via multiple communication links 1401 and 1402. For example, the communication links 1401 and 1402 may be example implementations of the communication links 1201 and 1202, respectively, of FIG. 12.

Existing versions of the IEEE 802.11 standard define a roaming procedure that allows a STA to associate with a new AP when a received signal strength indication (RSSI) of wireless communication with a currently associated AP falls below an RSSI threshold. More specifically, upon determining that the RSSI of communication with its current AP is below the RSSI threshold, the STA may begin scanning for a new AP to associate with (also referred to as a “roaming scan”). Some mesh networks are capable of “steering” a STA to different APs to improve a quality of communication with the STA while preempting roaming scans. For example, an AP in a mesh network may monitor an RSSI of wireless communication with an associated STA (such as reported by the STA). When the RSSI falls below an RSSI threshold (which is often much higher than the RSSI threshold at which roaming is triggered), the AP may recommend that the STA associate with another AP in the mesh network that is expected to provide a higher RSSI of wireless communication.

According to existing steering protocols for MLO, an AP MLD combines the RSSI values observed on each of its communication links with a STA MLD and compares the combined RSSI with a given RSSI threshold. However, aspects of the present disclosure recognize that a sparingly used link associated with low RSSI can cause false steering triggers, which can result in thrashing. For example, an AP MLD may detect (or extrapolate) a high RSSI on a primary link, and a low RSSI on a secondary link, with a STA MLD. In some implementations, the combined RSSI is less than an RSSI threshold for steering. As a result, the AP MLD may steer the STA MLD to a new AP MLD in the mesh network. However, upon associating with the new AP MLD, the STA MLD may determine that the RSSI of communication on its primary link is lower than an RSSI threshold for roaming. As a result, the STA MLD may initiate a roaming scan to search for yet another AP to associate with.

In some aspects, an AP MLD may weight the RSSIs detected (or extrapolated) on each of its communication links based on one or more LRMs associated with the link. More specifically, communication links associated with higher LRMs may be weighted more heavily than communication links associated with lower LRMs. For example, the AP MLD 1410 may assign a weight (λ) to the RSSI of communication on the communication link 1401 (RSS1) based on an LRM (or average LRM) associated with the communication link 1401. The AP MLD 1410 also may assign a weight (γ) to the RSSI of communication on the second communication link 1402 (RSSI2) based on an LRM (or average LRM) associated with the communication link 1402. In some implementations, the weights λ and γ may be set or specified by an operator cloud (such as the operator cloud 610 of FIG. 6). In some implementations, the RSSI threshold associated with the steering operation also may be set or specified by the operator cloud.

In the example of FIG. 14, the communication link 1401 is a primary link and the communication link 1402 is a secondary link. Thus, as shown in FIG. 14, the average LRM associated with the communication link 1401 (LRM₁=40%) is greater than the average LRM associated with the communication link 1402 (LRM₂=13%). Thus, in determining whether to steer the STA MLD 1430 to a new AP, the AP MLD 1410 may assign a greater weight to RSSI1 than to RSSI2 (λ>γ). For example, if a combination of λRSSI1 and γRSS2 is less than an RSSI threshold, the AP MLD 1410 may steer the STA MLD 1430 to a new AP (such as the AP MLD 1420). Otherwise, if the combination of λRSSI1 and γRSS2 is greater than the RSSI threshold, the STA MLD 1430 may remain associated with the AP MLD 1410.

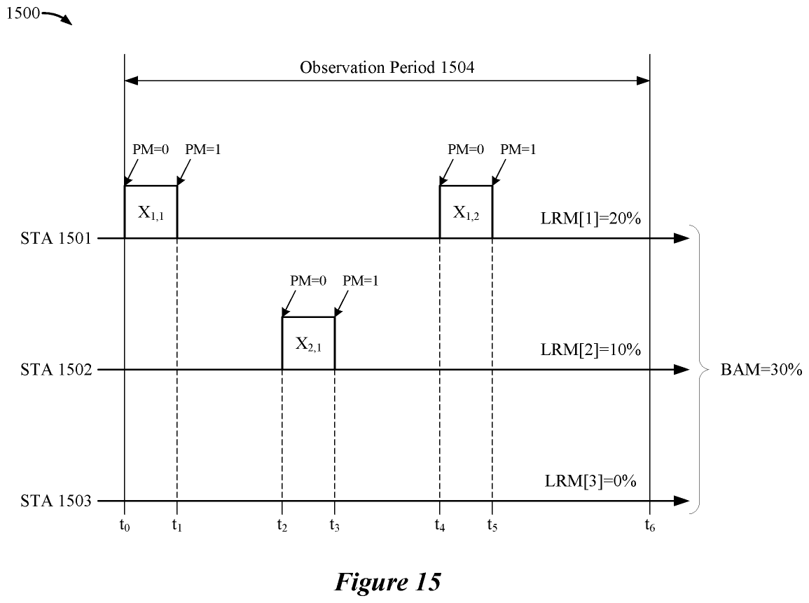

FIG. 15 shows a timing diagram 1500 depicting example link residency profiles of multiple STAs 1501-1503 associated with an AP. In some implementations, the AP may be one example of any of the APs 102, 502, or 620 of FIGS. 1, 5A, and 6, respectively. In some implementations, each of the STAs 1501-1503 may be one example of any of the STAs 104 or 504 of FIGS. 1 and 5B, respectively. For simplicity, three STAs 1501-1503 are shown in FIG. 15. However, in some other implementations, the AP may be associated with fewer or more STAs than those depicted in FIG. 15.

As described with reference to FIG. 7A, the AP may observe or monitor a residency of each of the STAs 1501-1503 on a particular wireless communication link or channel. More specifically, the AP may measure a duration of each interval (X) that a STA is resident on the link based on power management information carried in one or more packets received from the STA. For example, the AP may measure the duration of each link residency interval X as the elapsed time between the reception of a first packet (such as an NDP) having a PM bit set to 1 and the reception of a second packet (such as a subsequent NDP) having a PM bit set to 0.

With reference to Equation 1, the AP may calculate (such as determine) or otherwise derive a respective LRM for each of the STAs 1501-1503 based on a number (N) of link residency intervals (X_{i,j}) measured over the duration (T_{obs}) of an observation period 1504, between times t₀ and t₆. In some implementations, LRM[i] represents the LRM for the i^{th} STA. In the example of FIG. 15, the STAs 1501, 1502, and 1503 are assigned to indexes i=1, 2, and 3, respectively. In some implementations, the AP may further calculate (such as determine) or otherwise derive a BSS Activity Metric (BAM) for the BSS associated with a given link (or channel) based on the LRMs associated with a number (M) of STAs operating on the link:

$$BAM = {\sum }_{i = 1}^{M} L R M [ i ] \qquad ( 4 )$$

Thus, BAM indicates an average amount of time all STAs associated with a BSS are in the awake state on a given link.

The STA 1501 transmits, at time t₀, a packet having a PM bit set to 0, and further transmits, at time t₁, a packet having a PM bit set to 1. Thus, the AP may measure a first link residency interval X_{1,1} of the STA 1501 as the duration between times t₀ and t₁. The STA 1502 transmits, at time t₂, a packet having a PM bit set to 0, and further transmits, at time t₃, a packet having a PM bit set to 1. Thus, the AP may measure a link residency interval X_{2,1} of the STA 1502 as the duration between times t₂ and t₃. The STA 1501 transmits, at time t₄, another packet having a PM bit set to 0, and further transmits, at time t₅, another packet having a PM bit set to 1. Thus, the AP may measure a second link residency interval X_{1,2} of the STA 1501 as the duration between times t₄ and t₅.

After summing X_{1,1} and X_{1,2} and dividing the sum by T_{obs}, the AP may determine that the STA 1501 is resident on the link 20% of the observation period 1504 (LRM[1]=20%). Further, after dividing X_{2,1} by T_{obs}, the AP may determine that the STA 1502 is resident on the link 10% of the observation period 1504 (LRM[2]=10%). As shown in FIG. 15, the STA 1503 is not resident on the given link for the duration of the observation period 1504 (LRM[3]=0%). In some implementations, the AP may sum LRM[1], LRM[2], and LRM[3] to determine that the STAs 1501-1503 are collectively resident on the link 30% of the observation period 1504 (BAM=30%).

In some implementations, the AP may maintain a moving average of the BAM associated with a given link across multiple observation periods. For example, the moving average (BAM_{avg}) can be calculated (such as determined) as a function of BAM, the prior moving average (BAM_{avg}⁰) at the time of acquiring BAM, and a weighting factor (β):

$$B A {M}_{avg} = β * B A M + ( 1 - β ) B A {M}_{avg}^{0} \qquad ( 5 )$$

In some implementations, the AP may dither or otherwise vary the durations of the observation periods, for example, to prevent the moving averages from falling into a beat pattern with the variations in a STA's residency profile (such as described with reference to FIG. 7B).

Aspects of the present disclosure recognize that BAMs can be used to improve the performance of one or more control loops. With reference for example to FIG. 6, the BAMs may be calculated (such as determined) or observed by the resource manager 622. More specifically, the resource manager 622 may use the BAM to configure or adjust one or more mid control loops 604. For example, by knowing how often the STAs 1501-1503 are collectively resident on a given link, the resource manager 622 can provision resources for wireless communication with the STAs 1501-1503 in a manner that improves the efficiency of the network. In some implementations, the resource manager 622 may dynamically reduce a power consumption of the AP 620 if the BAM is lower than a BAM threshold. In such implementations, the BAM threshold may be set or specified by an operator cloud (such as the operator cloud 610). In some other implementations, the resource manager 622 may provide the BAM to one or more STAs. For example, the BAM may assist in the roaming decisions of the one or more STAs.

In the example of FIG. 15, the BAM threshold for reducing the power of the AP may be set at 40%. Because the BAM associated with the given link (BAM=30%) is less than the BAM threshold, the AP may reduce its power consumption, for example, by operating in an “energy efficient” mode. In some implementations, the AP may power down or otherwise deactivate one or more wireless radios or RF chains (such as one or more transmitter chains, one or more receiver chains, or any combination thereof) when operating in the energy efficient mode. In some other implementations, the AP may only listen to wireless communication on a 20 MHz channel, and enable dynamic clock gating of one or more hardware blocks, when operating in the energy efficient mode. Still further, in some implementations, the AP may disable or otherwise refrain from operating on one or more communication links with a STA MLD when operating in the energy efficient mode.

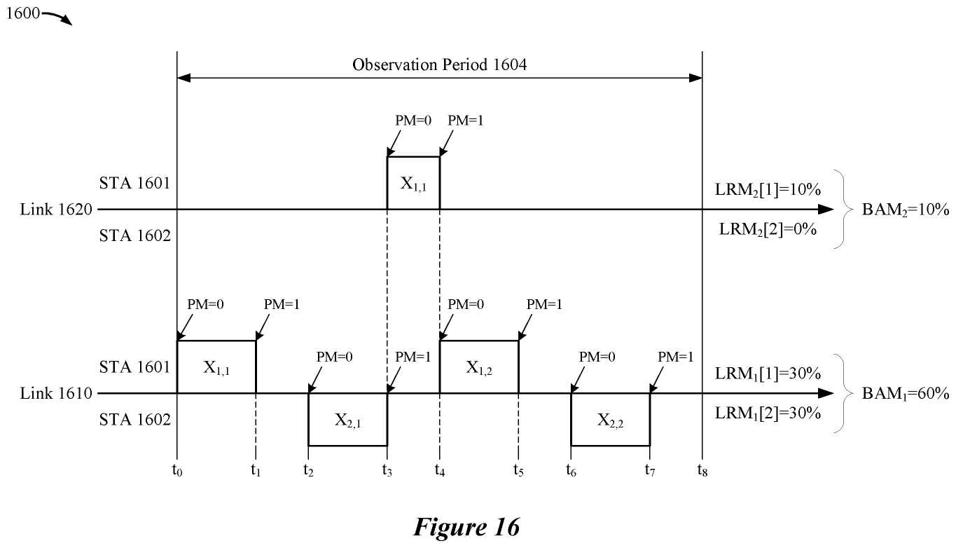

FIG. 16 shows a timing diagram 1600 depicting example link residency profiles of multiple STA MLDs 1601 and 1602 associated with an AP MLD. In some implementations, the AP MLD may be one example of any of the APs 102, 502, or 620 of FIGS. 1, 5A, and 6, respectively. In some implementations, each of the STA MLDs 1601 and 1602 may be one example of any of the STAs 104 or 504 of FIGS. 1 and 5B, respectively. In the example of FIG. 16, each of the STA MLDs 1601 and 1602 is shown to communicate with the AP MLD over a pair of communication links 1610 and 1620. However, in some other implementations, the AP MLD may communicate with any number of STA MLDs over any number of communication links.

As described with reference to FIG. 12, the AP MLD may observe or monitor a residency of each of the STA MLDs 1601 and 1602 on each of the communication links 1610 and 1620. More specifically, the AP may measure a duration of each interval (X) that a STA MLD is resident on a given link based on power management information carried in one or more packets received from the STA MLD. For example, the AP MLD may measure the duration of each link residency interval X as the elapsed time between the reception of a first packet (such as an NDP) having a PM bit set to 1 and the reception of a second packet (such as a subsequent NDP) having a PM bit set to 0.

With reference to Equation 3, the AP MLD may calculate (such as determine) or otherwise derive a respective LRM for each of the STA MLDs 1601 and 1602, on each of the links 1610 and 1620, based on a number (N) of link residency intervals (Xᵢⱼ) measured over the duration (T_{obs}) of an observation period 1604, between times t₀ and t₅. In some implementations, LRMₖ[i] represents the LRM for the i^{th} STA MLD operating on the k^{th} link. In the example of FIG. 16, the STA MLDs 1601 and 1602 are assigned to indexes i=1 and 2, respectively. In some implementations, the AP may further calculate (such as determine) or otherwise derive a respective BAM for each of the communication links 1610 and 1620 based on the LRMs associated with a number (M) of STAs operating on the link. In some implementations, BAMₖ represents the BAM for the k^{th} communication link:

$${BAM}_{k} = {\sum }_{i = 1}^{M} L R M [ i ] \qquad ( 6 )$$

Thus, BAMₖ indicates an average amount of time all STAs associated with a BSS are in the awake state on the k^{th} communication link.

The STA MLD 1601 transmits, at time t₀, a packet having a PM bit set to 0 on the link 1610, and further transmits, at time t₁, a packet having a PM bit set to 1 on the link 1610. Thus, the AP MLD may measure a link residency interval X_{1,1} on the link 1610 as the duration between times t₀ and t₁. The STA MLD 1602 transmits, at time t₂, a packet having a PM bit set to 0 on the link 1610, and further transmits, at time t₃, a packet having a PM bit set to 1 on the link 1610. Thus, the AP MLD may measure a link residency interval X_{2,1} on the link 1610 as the duration between times t₂ and t₃. The STA MLD 1601 transmits, at time t₃, a packet having a PM bit set to 0 on the link 1620, and further transmits, at time t₄, a packet having a PM bit set to 1 on the link 1620. Thus, the AP MLD may measure a second link residency interval X_{1,1} on the link 1620 as the duration between times t₃ and t₄.

The STA MLD 1601 transmits, at time t₄, another packet having a PM bit set to 0 on the link 1610, and further transmits, at time t₅, another packet having a PM bit set to 1 on the link 1610. Thus, the AP MLD may measure a link residency interval X_{1,2} on the link 1610 as the duration between times t₄ and t₅. The STA MLD 1602 transmits, at time t₆, another packet having a PM bit set to 0 on the link 1610, and further transmits, at time t₇, another packet having a PM bit set to 1 on the link 1610. Thus, the AP MLD may measure a link residency interval X_{2,2} on the link 1610 as the duration between times t₂ and t₃.

After summing X_{1,1} and X_{1,2} on the link 1610 and dividing the sum by T_{obs}, the AP MLD may determine that the STA MLD 1601 is resident on the link 1610 30% of the observation period 1604 (LRM₁[1]=30%). After summing X_{2,1} and X_{2,2} on the link 1610 and dividing the sum by T_{obs}, the AP MLD may determine that the STA MLD 1602 is resident on the link 1610 30% of the observation period 1604 (LRM₁[2]=30%). Further, after dividing X_{1,1} on the link 1620 by T_{obs}, the AP may determine that the STA MLD 1601 is resident on the link 1620 10% of the observation period 1604 (LRM₂[1]=10%). As shown in FIG. 16, the STA MLD 1602 is not resident on the link 1620 for the duration of the observation period 1604 (LRM₂[2]=0%).

The AP may sum LRM₁[1] and LRM₁[2] to determine that the STA MLDs 1601 and 1602 are collectively resident on the link 1610 60% of the observation period 1604 (BAM₁=60%) and may further sum LRM₂[1] and LRM₂[2] to determine that the STA MLDs 1601 and 1602 are collectively resident on the link 1620 10% of the observation period 1604 (BAM₂=10%). In some implementations, the AP MLD may maintain a moving average of the BAMs on each of the links 1610 and 1620 across multiple observation periods. For example, a respective moving average (BAM_{avg}) can be calculated (such as determined) for each of the links 1610 and 1620 according to Equation 5 (such as described with reference to FIG. 15). In some implementations, the AP may dither or otherwise vary the durations of the observation periods, for example, to prevent the moving averages from falling into a beat pattern with the variations in a STA's residency profile (such as described with reference to FIG. 7B).

In some aspects, the AP MLD may disable or otherwise refrain from operating on a communication link associated with a BAM that is less than a BAM threshold. In some implementations, the BAM threshold may be set or otherwise specified by an operator cloud (such as the operator cloud 610 of FIG. 6). In the example of FIG. 16, the BAM threshold for disabling a particular communication link may be set at 30%. In other words, the AP MLD may disable a communication link if a BAM (or average BAM) associated with the link is less than 30%. As shown in FIG. 16, the average BAM associated with link 1610 (BAM₁=60%) is greater than the BAM threshold, whereas the average BAM associated with the link 1620 (BAM₂=10%) is less than the BAM threshold. Thus, the AP MLD may disable the communication link 1620 when operating in an energy efficient mode.

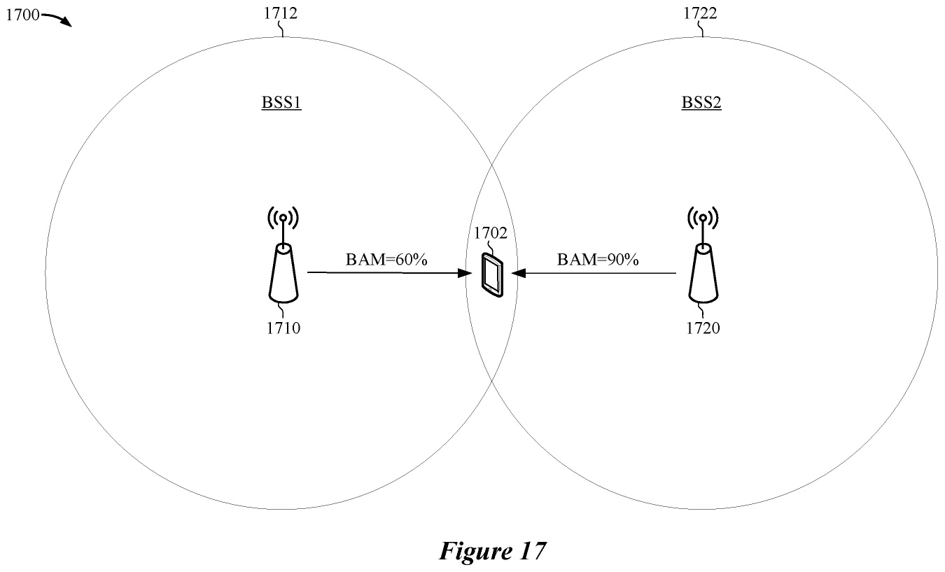

FIG. 17 shows an example communication environment 1700 with OBSSs, according to some implementations. More specifically, the example communication environment 1700 includes a STA 1702 and multiple APs 1710 and 1720. In some implementations, the STA 1702 may be one example of any of the STAs 104 or 504 of FIGS. 1 and 5B, respectively. In some implementations, each of the APs 1710 and 1720 may be one example of any of the APs 102, 502, or 620 of FIGS. 1, 5A, and 6, respectively. The APs 1710 and 1720 may represent BSSs (BSS1 and BSS2) having overlapping coverage areas 1712 and 1722, respectively. In the example of FIG. 17, each of the APs 1710 and 1720 may be configured to operate on the same wireless channel. Accordingly, BSS1 and BSS2 represent overlapping BSSs (OBSSs).

The STA 1702 may be associated with the AP 1710 but is located at the edge of the coverage area 1712. More specifically, as shown in FIG. 17, the STA 1702 is located at the intersection of the coverage areas 1712 and 1722. As described with reference to FIG. 14, existing versions of the IEEE 802.11 standard define a roaming procedure that allows a STA to associated with a new AP when an RSSI of wireless communication with a currently associated AP falls below an RSSI threshold. However, RSSI, alone, may not be a reliable indicator of long-term performance. For example, interference from multiple STAs that are concurrently active on the same wireless channel may cause the RSSI experienced by any of the STAs to be artificially low. However, the likelihood (or frequency) of the STAs being active on the wireless channel may be relatively low. Thus, aspects of the present disclosure recognize that the BAM associated with an AP (such as in combination with RSSI) may be a more reliable indicator of long-term performance characteristics of the AP.

In some aspects, an AP may advertise BAM information to one or more STAs in its vicinity. The BAM information may indicate the BAM(s) associated with one or more communication links supported by the AP. In some implementations, the AP may transmit or broadcast the BAM information in beacon frames (or other management frames) transmitted or broadcast by the AP. For example, the BAM information may be carried in a vendor specific information element of the beacon frames. In some implementations, a STA may use the BAM information to determine whether to roam to a new AP. For example, the STA may choose not to roam to a new AP if the BAM associated with its current AP is relatively low (such as below a BAM threshold). In some other implementations, a STA may use the BAM information to select an AP to associate with. For example, the STA may select the AP associated with the highest BAM among the candidate APs.

In the example of FIG. 17, the STA 1702 may determine that the RSSI of its communication with the AP 1710 is below an RSSI threshold for roaming. However, as shown in FIG. 17, the AP 1720 is the only roaming candidate for the STA 1702. The STA 1702 may determine that the AP 1710 is associated with a BAM equal to 60% based on BAM information carried in one or more packets (such as beacon frames) received form the AP 1710. The STA 1702 also may determine that the AP 1720 is associated with a BAM equal to 90% based on BAM information carried in one or more packets (such as beacon frames) received from the AP 1720. Because the STAs associated with the AP 1720 have much higher link residencies than the STAs associated with the AP 1710, the STA 1702 may decide to remain associated with the AP 1710 (rather than roam to the AP 1720).

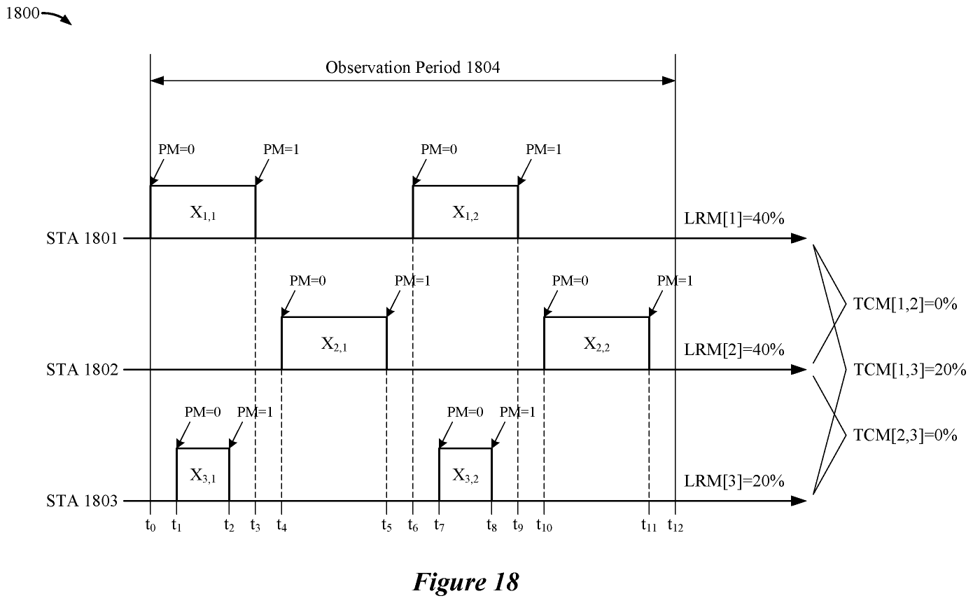

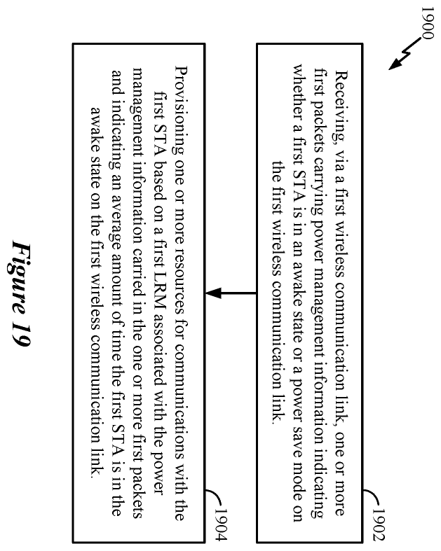

FIG. 18 shows a timing diagram 1800 depicting example link residency profiles of multiple STAs 1801-1803 associated with an AP. In some implementations, the AP may be one example of any of the APs 102, 502, or 620 of FIGS. 1, 5A, and 6, respectively. In some implementations, each of the STAs 1801-1803 may be one example of any of the STAs 104 or 504 of FIGS. 1 and 5B, respectively. For simplicity, three STAs 1801-1803 are shown in FIG. 18. However, in some other implementations, the AP may be associated with fewer or more STAs than those depicted in FIG. 18.

As described with reference to FIG. 7A, the AP may observe or monitor a residency of each of the STAs 1801-1803 on a particular wireless communication link or channel. More specifically, the AP may measure a duration of each interval (X) that a STA is resident on the link based on power management information carried in one or more packets received from the STA. For example, the AP may measure the duration of each link residency interval X as the elapsed time between the reception of a first packet (such as an NDP) having a PM bit set to 1 and the reception of a second packet (such as a subsequent NDP) having a PM bit set to 0.

With reference to Equation 1, the AP may calculate (such as determine) or otherwise derive a respective LRM for each of the STAs 1801-1803 based on a number of link residency intervals (X_{i,j}) measured over the duration (T_{obs}) of an observation period 1804, between times t₀ and t₁₂. In some implementations, LRM[i] represents the LRM for the i^{th} STA. In the example of FIG. 18, the STAs 1801, 1802, and 1803 are assigned to indexes i=1, 2, and 3, respectively. In some implementations, the AP may further calculate (such as determine) or otherwise derive a time coherency metric (TCM) for any given pair (or subset) of STAs operating on a given link (or channel) based on the LRMs associated with the n^{th} and m^{th} STAs operating on the link. In some implementations, the n^{th} STA has a number (N) of link residency intervals, and the m^{th} STA has a number (M) of link residency intervals, within T_{obs}:

$$T C M [ n , m ] = {\sum }_{k = 1}^{M} {\sum }_{j = 1}^{N} {X}_{m , k} ∩ {X}_{n , j} \qquad ( 7 )$$

Thus, TCM indicates an average amount of time a pair (or subset) of STAs are in the awake state on a given link.

The STA 1801 transmits, at time t₀, a packet having a PM bit set to 0, and further transmits, at time t₃, a packet having a PM bit set to 1. Thus, the AP may measure a first link residency interval X_{1,1} of the STA 1801 as the duration between times t₀ and t₃. The STA 1801 transmits, at time t₆, a packet having a PM bit set to 0, and further transmits, at time t₉, a packet having a PM bit set to 1. Thus, the AP may measure a second link residency interval X_{1,2} of the STA 1801 as the duration between times t₆ and t₉. After summing X_{1,1} and X_{1,2} and dividing the sum by T_{obs}, the AP may determine that the STA 1801 is resident on the link 40% of the observation period 1804 (LRM[1]=40%).

The STA 1802 transmits, at time t₄, a packet having a PM bit set to 0, and further transmits, at time t₅, a packet having a PM bit set to 1. Thus, the AP may measure a first link residency interval X_{2,1} of the STA 1802 as the duration between times t₄ and t₅. The STA 1802 transmits, at time t₁₀, a packet having a PM bit set to 0, and further transmits, at time t₁₁, a packet having a PM bit set to 1. Thus, the AP may measure a link residency interval X_{2,2} of the STA 1802 as the duration between times t₁₀ and t₁₁. After summing X_{2,1} and X_{2,2} and dividing the sum by T_{obs}, the AP may determine that the STA 1802 is resident on the link 40% of the observation period 1804 (LRM[2]=40%).

The STA 1803 transmits, at time t₁, a packet having a PM bit set to 0, and further transmits, at time t₂, a packet having a PM bit set to 1. Thus, the AP may measure a first link residency interval X_{3,1} of the STA 1803 as the duration between times t₁ and t₂. The STA 1803 transmits, at time t₇, a packet having a PM bit set to 0, and further transmits, at time t₅, a packet having a PM bit set to 1. Thus, the AP may measure a link residency interval X_{3,2} of the STA 1803 as the duration between times t₇ and t₈. After summing X_{3,1} and X_{3,2} and dividing the sum by T_{obs}, the AP may determine that the STA 1803 is resident on the link 20% of the observation period 1804 (LRM[3]=20%).

As shown in FIG. 18, the STAs 1801 and 1802 are resident on the link at orthogonal times. Thus, the AP may determine that the TCM associated with the STAs 1801 and 1802 is equal to 0% (TCM[1,2]=0%). Further, the STAs 1802 and 1803 are also resident on the link at orthogonal times. Thus, the AP may determine that the TCM associated with the STAs 1802 and 1803 is equal to 0% (TCM[2,3]=0%). By contrast, the STAs 1801 and 1803 are both resident on the link from times t₁ to t₂ and from times t₇ to t₈. Thus, the AP may determine that the TCM associated with the STAs 1801 and 1803 is equal to 20% (TCM[1,3]=20%).

Aspects of the present disclosure recognize that TCMs can be used to improve the performance of one or more control loops. With reference for example to FIG. 6, the TCMs may be calculated (such as determined) or observed by the resource manager 622. More specifically, the resource manager 622 may use the TCMs to configure or adjust one or more mid control loops 604. For example, by knowing how often a given pair (or subset) of STAs are resident on a given link at the same time, the resource manager 622 can provision resources for wireless communication with the STAs 1801-1803 in a manner that improves the efficiency of the network. In some implementations, the resource manager 622 may selectively assign a pair or subset of STAs to an MU group based the TCMs associated with the STAs. For example, the resource manager 622 may assign two or more STAs to an MU group if the two or more STAs are concurrently resident on the link for at least a TCM threshold. In some implementations, the TCM threshold may be set or specified by an operator cloud (such as the operator cloud 610).

In the example of FIG. 18, the TCM threshold for MU grouping may be set at 20%. In other words, two or more STAs may be assigned to an MU group if a TCM associated with the two or more STAs is greater than or equal to 20%. Because the TCM associated with the STAs 1801 and 1803 (TCM[1,3]=20%) is equal to the TCM threshold, the AP may assign the STAs 1801 and 1803 to the same MU group. By contrast, the STAs 1801 and 1802 may not be assigned to the same MU group because the TCM associated with the STAs 1801 and a 1802 (TCM[1,2]=0%) is less than the TCM threshold (even though the LRMs associated with each of the STAs 1801 and 1802 is relatively high). In some implementations, the AP may store the data associated with two or more STAs in on-chip memory (such as the on-chip memory 1050 of FIG. 10) if the TCM associated with the two or more STAs is greater than or equal to the TCM threshold, for example, to support faster convergence of algorithms related to communication with a group of STAs (such as MU or target wake time (TWT) operation).

FIG. 19 shows a flowchart illustrating an example process 1900 for wireless communication that supports link state discriminants. In some implementations, the process 1900 may be performed by a wireless communication device operating as or within an AP, such as one of the APs 102, 502, or 620 described above with reference to FIGS. 1, 5A, and 6, respectively.

In some implementations, the process 1900 begins in block 1902 with receiving, via a first wireless communication link, one or more first packets carrying power management information indicating whether a first STA is in an awake state or a power save mode on the first wireless communication link. In block 1904, the process 1900 proceeds with provisioning one or more resources for communication with the first STA based on a first LRM associated with the power management information carried in the one or more first packets and indicating an average amount of time the first STA is in the awake state on the first wireless communication link.

In some aspects, the wireless communication device may further receive, via the first wireless communication link, one or more second packets carrying power management information indicating whether a second STA is in an awake state or a power save mode on the first wireless communication link. In some implementations, the provisioning of the one or more resources is further based on a second LRM associated with the power management information carried in the one or more second packets and indicating an average amount of time the second STA is in the awake state on the first wireless communication link. In some implementations, the provisioning of the one or more resources may include provisioning a first spatial stream to the first STA and a second spatial stream to the second STA based on each of the first LRM and the second LRM being greater than a threshold value. In some implementations, the first and second spatial streams are provisioned for concurrent communication with a MU-MIMO group.

In some aspects, the provisioning of the one or more resources may be further based on a TCM associated with the power management information carried in the one or more first packets and the power management information carried in the one or more second packets. In some implementations, the TCM indicates an average amount of time the first STA and the second STA are concurrently in the awake state on the first wireless communication link. In some other aspects, the provisioning of the one or more resources may be further based on a BAM indicating an average amount of time all STAs associated with the wireless communication device are in the awake state on the first wireless communication link.

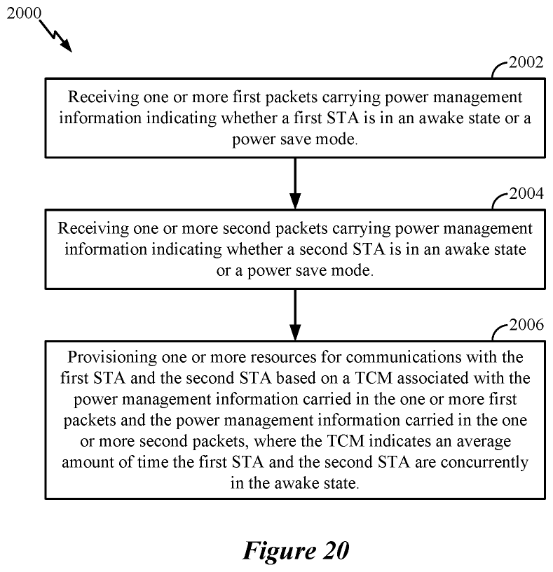

FIG. 20 shows a flowchart illustrating an example process 2000 for wireless communication that supports link state discriminants. In some implementations, the process 2000 may be performed by a wireless communication device operating as or within an AP, such as one of the APs 102, 502, or 620 described above with reference to FIGS. 1, 5A, and 6, respectively.

In some implementations, the process 2000 begins in block 2002 with receiving one or more first packets carrying power management information indicating whether a first STA is in an awake state or a power save mode. In block 2004, the process 2000 proceeds with receiving one or more second packets carrying power management information indicating whether a second STA is in an awake state or a power save mode. In block 2006, the process 2000 proceeds with provisioning one or more resources for communication with the first STA and the second STA based on a TCM associated with the power management information carried in the one or more first packets and the power management information carried in the one or more second packets. In some implementations, the TCM indicates an average amount of time the first STA and the second STA are concurrently in the awake state.

In some implementations, the provisioning of the one or more resources may include provisioning a first spatial stream to the first STA and a second spatial stream to the second STA based on the TCM being greater than a threshold value. In some implementations, the first and second spatial streams are provisioned for concurrent communication with an MU-MIMO group. In some aspects, the provisioning of the one or more resources may be further based on a first LRM associated with the power management information carried in the one or more first packets and a second LRM associated with the power management information carried in the one or more second packets. In some implementations, the first LRM indicates an average amount of time the first STA is in the awake state and the second LRM indicates an average amount of time the second STA is in the awake state.

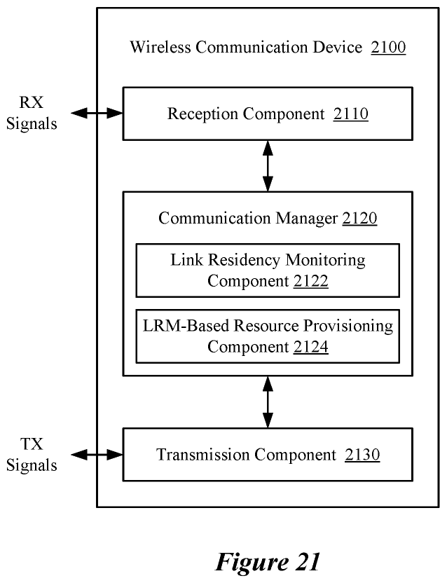

FIG. 21 shows a block diagram of an example wireless communication device 2100 according to some implementations. In some implementations, the wireless communication device 2100 may be configured to perform the process 1900 described above with reference to FIG. 19. The wireless communication device 2100 can be an example implementation of the wireless communication device 400 described above with reference to FIG. 4. For example, the wireless communication device 2100 can be a chip, SoC, chipset, package or device that includes at least one processor and at least one modem (for example, a Wi-Fi (IEEE 802.11) modem or a cellular modem).

The wireless communication device 2100 includes a reception component 2110, a communication manager 2120, and a transmission component 2130. The communication manager 2120 further includes link residency monitoring component 2122 and an LRM-based resource provisioning component 2124. Portions of one or more of the components 2122 and 2124 may be implemented at least in part in hardware or firmware. In some implementations, at least some of the components 2122 or 2124 are implemented at least in part as software stored in a memory (such as the memory 408). For example, portions of one or more of the components 2122 and 2124 can be implemented as non-transitory instructions (or “code”) executable by a processor (such as the processor 406) to perform the functions or operations of the respective component.

The reception component 2110 is configured to receive RX signals, over a wireless channel, from one or more other wireless communication devices. The transmission component 2130 is configured to transmit TX signals, over a wireless channel, to one or more other wireless communication devices. The communication manager 2120 is configured to control or manage communication with one or more other wireless communication devices. In some implementations, the link residency monitoring component 2122 may receive, via a wireless communication link, one or more packets carrying power management information indicating whether a STA is in an awake state or a power save mode on the first wireless communication link; and the LRM-based resource provisioning component 2124 may provision one or more resources for communication with the STA based on an LRM associated with the power management information carried in the one or more packets and indicating an average amount of time the first STA is in the awake state on the first wireless communication link.

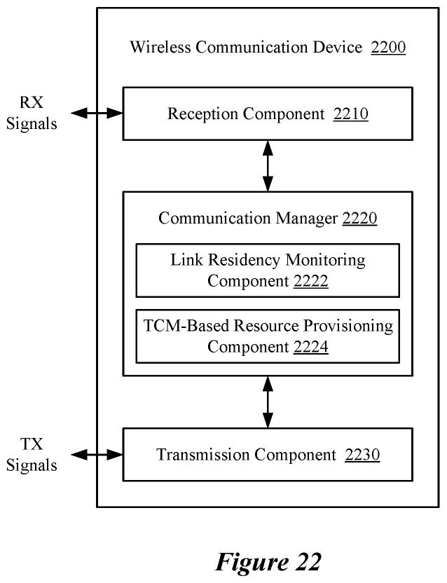

FIG. 22 shows a block diagram of an example wireless communication device 2200 according to some implementations. In some implementations, the wireless communication device 2200 may be configured to perform the process 2000 described above with reference to FIG. 20. The wireless communication device 2200 can be an example implementation of the wireless communication device 400 described above with reference to FIG. 4. For example, the wireless communication device 2200 can be a chip, SoC, chipset, package or device that includes at least one processor and at least one modem (for example, a Wi-Fi (IEEE 802.11) modem or a cellular modem).

The wireless communication device 2200 includes a reception component 2210, a communication manager 2220, and a transmission component 2230. The communication manager 2220 further includes link residency monitoring component 2222 and a TCM-based resource provisioning component 2224. Portions of one or more of the components 2222 and 2224 may be implemented at least in part in hardware or firmware. In some implementations, at least some of the components 2222 or 2224 are implemented at least in part as software stored in a memory (such as the memory 408). For example, portions of one or more of the components 2222 and 2224 can be implemented as non-transitory instructions (or “code”) executable by a processor (such as the processor 406) to perform the functions or operations of the respective component.

The reception component 2210 is configured to receive RX signals, over a wireless channel, from one or more other wireless communication devices. The transmission component 2230 is configured to transmit TX signals, over a wireless channel, to one or more other wireless communication devices. The communication manager 2220 is configured to control or manage communication with one or more other wireless communication devices. In some implementations, the link residency monitoring component 2222 may receive one or more first packets carrying power management information indicating whether a first STA is in an awake state or a power save mode, and may further receive one or more second packets carrying power management information indicating whether a second STA is in an awake state or a power save mode; and the TCM-based resource provisioning component 2224 may provision one or more resources for communication with the first STA and the second STA based on a TCM associated with the power management information carried in the one or more first packets and the power management information carried in the one or more second packets. In some implementations, the TCM indicates an average amount of time the first STA and the second STA are concurrently in the awake state.

Implementation examples are described in the following numbered clauses:

1. A method for wireless communication by a wireless communication device, including:
receiving, via a first wireless communication link, one or more first packets carrying power management information indicating whether a first wireless station (STA) is in an awake state or a power save mode on the first wireless communication link; and
provisioning one or more resources for communication with the first STA based on a first link residency metric (LRM) associated with the power management information carried in the one or more first packets and indicating an average amount of time the first STA is in the awake state on the first wireless communication link.

2. The method of clause 1, wherein the one or more resources include time, frequency, multi-user streams, memory, buffers, or processing resources.

3. The method of any of clauses 1 or 2, further including:
measuring a duration of each interval that the first STA is in the awake state on the first wireless communication link during a first observation period based on the power management information carried in the one or more first packets; and
calculating the first LRM as a sum of the durations that the first STA is in the awake state on the first wireless communication link during the first observation period divided by a duration of the first observation period.

4. The method of any of clauses 1-3, further including:
receiving, via the first wireless communication link, one or more second packets carrying power management information indicating whether the first STA is in the awake state or the power save mode on the first wireless communication link;
measuring a duration of each interval that the first STA is in the awake state on the first wireless communication link during a second observation period based on the power management information carried in the one or more second packets; and
calculating a second LRM as a sum of the durations that the first STA is in the awake state on the first wireless communication link during the second observation period divided by a duration of the second observation period.

5. The method of any of clauses 1-4, wherein the duration of the first observation period is different than the duration of the second observation period.

6. The method of any of clauses 1-5, wherein the provisioning of the one or more resources is further based on a moving average associated with the first LRM and the second LRM.

7. The method of any of clauses 1-6, wherein the provisioning of the one or more resources includes:
buffering data for transmission to the first STA in a local memory based on the first LRM being greater than a threshold value, the local memory being disposed on a chip that includes physical layer (PHY) hardware associated with the transmission of the data; and
buffering the data for transmission to the first STA in a remote memory based on the first LRM being less than or equal to the threshold value, the remote memory being external to the chip that includes the PHY hardware.

8. The method of any of clauses 1-7, further including:
receiving, from a network controller, control information indicating the threshold value.

9. The method of any of clauses 1-8, further including:
receiving, via a second wireless communication link, one or more second packets carrying power management information indicating whether the first STA is in the awake state or the power save mode on the second wireless communication link, the provisioning of the one or more resources being further based on a second LRM associated with the power management information carried in the one or more second packets and indicating an average amount of time the first STA is in the awake state on the second wireless communication link.

10. The method of any of clauses 1-9, wherein the provisioning of the one or more resources includes:
mapping the communication to the first wireless communication link, in lieu of the second wireless communication link, based on the first LRM being greater than the second LRM by a threshold amount, the first and second wireless communication links representing primary and secondary links, respectively, associated with a multi-link communication with the first STA.

11. The method of any of clauses 1-10, further including:
receiving, from a network controller, control information indicating the threshold amount.

12. The method of any of clauses 1-11, wherein the provisioning of the one or more resources includes:
obtaining a first received signal strength indication (RSSI) associated with the first wireless communication link;
obtaining a second RSSI associated with the second wireless communication link; and
steering the communication to a neighboring access point (AP) based on a first weighted RSSI and a second weighted RSSI being greater than a combined RSSI threshold, the first weighted RSSI being equal to the first RSSI multiplied by a weighting factor associated with the first LRM and the second weighted RSSI being equal to the second RSSI multiplied by a weighting factor associated with the second LRM.

13. The method of any of clauses 1-12, further including:
receiving, from a network controller, control information indicating the weighting factor associated with the first LRM and the weighting factor associated with the second LRM.

14. The method of any of clauses 1-13, further including:
receiving, via the first wireless communication link, one or more second packets carrying power management information indicating whether a second STA is in an awake state or a power save mode on the first wireless communication link, the provisioning of the one or more resources being further based on a second LRM associated with the power management information carried in the one or more second packets and indicating an average amount of time the second STA is in the awake state on the first wireless communication link.

15. The method of any of clauses 1-14, wherein the provisioning of the one or more resources includes:
provisioning a first spatial stream to the first STA and a second spatial stream to the second STA based on each of the first LRM and the second LRM being greater than a threshold value, the first and second spatial streams being provisioned for concurrent communication with a multi-user (MU) multiple-input multiple-output (MIMO) group.

16. The method of any of clauses 1-15, further including:
receiving, from a network controller, control information indicating the threshold value.

17. The method of any of clauses 1-16, wherein the provisioning of the one or more resources is further based on a time coherency metric (TCM) associated with the power management information carried in the one or more first packets and the power management information carried in the one or more second packets, the TCM indicating an average amount of time the first STA and the second STA are concurrently in the awake state on the first wireless communication link.

18. The method of any of clauses 1-17, wherein the provisioning of the first and second spatial streams is further based on the TCM being greater than a threshold TCM value.

19. The method of any of clauses 1-18, further including:
receiving, from a network controller, control information indicating the threshold TCM value.

20. The method of any of clauses 1-19, wherein the provisioning of the one or more resources includes:
provisioning a greater number of scheduling grants for the communication with the first STA than for communication with the second STA based on the first LRM being less than the second LRM, the communication with the first STA being associated with the same service-level agreement (SLA) service class as the communication with the second STA.

21. The method of any of clauses 1-20, wherein the provisioning of the one or more resources includes:
provisioning a number (N) of frame buffers to store data for transmission to the first STA; and
provisioning a number (M) of frame buffers to store data for transmission to the second STA, where N>M based on the first LRM being greater than the second LRM.

22. The method of any of clauses 1-21, further including:
receiving, from a network controller, control information indicating N and M.

23. The method of any of clauses 1-22, wherein the provisioning of the one or more resources includes:
mapping data associated with a first flow priority to a first packet queue for transmission to the first STA;
mapping data associated with a second flow priority to a second packet queue for transmission to the second STA; and
remapping at least some of the data associated with the first flow priority to the second packet queue based on the first packet queue storing at least a threshold amount of data and the second LRM being less than or equal to the first LRM.

24. The method of any of clauses 1-23, wherein the provisioning of the one or more resources is further based on a basic service set (BSS) activity metric (BAM) indicating an average amount of time all STAs associated with the wireless communication device are in the awake state on the first wireless communication link.

25. The method of any of clauses 1-24, wherein the BAM is associated with a sum of the first LRM and the second LRM.

26. The method of any of clauses 1-25, further including:
transmitting the BAM to the first STA and the second STA.

27. The method of any of clauses 1-26, wherein the provisioning of the one or more resources includes:
operating the wireless communication device in a low power mode based on the BAM being less than a threshold value.

28. The method of any of clauses 1-27, further including:
receiving, from a network controller, control information indicating the threshold value.

29. The method of any of clauses 1-28, wherein the operating of the wireless communication device in the low power mode includes:
reducing a range of frequencies listened to by the wireless communication device.

30. The method of any of clauses 1-29, wherein the operating of the wireless communication device in the low power mode includes:
deactivating one or more radio frequency (RF) chains associated with the wireless communication device.

31. The method of any of clauses 1-30, wherein the operating of the wireless communication device in the low power mode includes:
deactivating one of a plurality of wireless communication links that includes the first wireless communication link.

32. The method of any of clauses 1-31, further including:
receiving, from a network controller, control information indicating the provisioning of the one or more resources for communication with the first STA.

33. A wireless communication device including:
at least one processor; and
at least one memory communicatively coupled with the at least one processor and storing processor-readable code that, when executed by the at least one processor, is configured to perform the method of any one of clauses 1-32.

34. A method for wireless communication by a wireless communication device, including:
receiving one or more first packets carrying power management information indicating whether a first STA is in an awake state or a power save mode;
receiving one or more second packets carrying power management information indicating whether a second STA is in an awake state or a power save mode; and
provisioning one or more resources for communication with the first STA and the second STA based on a time coherency metric (TCM) associated with the power management information carried in the one or more first packets and the power management information carried in the one or more second packets, the TCM indicating an average amount of time the first STA and the second STA are concurrently in the awake state.

35. The method of any of clause 34, wherein the one or more resources include time, frequency, multi-user streams, memory, buffers, or processing resources.

36. The method of any of clauses 34 or 35, further including:
measuring a duration of each interval that the first STA and the second STA are concurrently in the awake state during an observation period based on the power management information carried in the one or more first packets and the power management information carried in the one or more second packets; and
calculating the TCM as a sum of the durations that the first STA and the second STA are concurrently in the awake state during the observation period divided by a duration of the observation period.

37. The method of any of clauses 34-36, wherein the provisioning of the one or more resources includes:
provisioning a first spatial stream to the first STA and a second spatial stream to the second STA based on the TCM being greater than a threshold value, the first and second spatial streams being provisioned for concurrent communication with a multi-user (MU) multiple-input multiple-output (MIMO) group.

38. The method of any of clauses 34-37, further including:
receiving, from a network controller, control information indicating the threshold value.

39. The method of any of clauses 34-38, wherein the provisioning of the one or more resources is further based on a first link residency metric (LRM) associated with the power management information carried in the one or more first packets and a second LRM associated with the power management information carried in the one or more second packets, the first LRM indicating an average amount of time the first STA is in the awake state and the second LRM indicating an average amount of time the second STA is in the awake state.

40. The method of any of clauses 34-39, wherein the provisioning of the first and second spatial streams is further based on each of the first LRM and the second LRM being greater than a threshold LRM value.

41. The method of any of clauses 34-40, further including:
receiving, from a network controller, control information indicating the threshold LRM value.

42. The method of any of clauses 34-41, further including:
measuring a duration of each interval that the first STA is in the awake state during a first observation period based on the power management information carried in the one or more first packets;
calculating the first LRM as a sum of the durations that the first STA is in the awake state during the first observation period divided by a duration of the first observation period;
measuring a duration of each interval that the second STA is in the awake state during the first observation period based on the power management information carried in the one or more second packets; and
calculating the second LRM as a sum of the durations that the second STA is in the awake state during the first observation period divided by the duration of the first observation period.

43. The method of any of clauses 34-42, further including:
receiving one or more third packets carrying power management information indicating whether the first STA is in the awake state or the power save mode;
measuring a duration of each interval that the first STA is in the awake state during a second observation period based on the power management information carried in the one or more third packets;
calculating a third LRM as a sum of the durations that the first STA is in the awake state during the second observation period divided by a duration of the second observation period;
receiving one or more fourth packets carrying power management information indicating whether the second STA is in the awake state or the power save mode;
measuring a duration of each interval that the second STA is in the awake state during the second observation period based on the power management information carried in the one or more fourth packets; and
calculating a fourth LRM as a sum of the durations that the second STA is in the awake state during the second observation period divided by the duration of the second observation period.

44. The method of any of clauses 34-43, wherein the duration of the first observation period is different than the duration of the second observation period.

45. The method of any of clauses 34-44, wherein the provisioning of the one or more resources is further based on a first moving average associated with the first LRM and the third LRM and a second moving average associated with the second LRM and the fourth LRM.

46. A wireless communication device including:
at least one processor; and
at least one memory communicatively coupled with the at least one processor and storing processor-readable code that, when executed by the at least one processor, is configured to perform the method of any one of clauses 34-45.

As used herein, a phrase referring to “at least one of” or “one or more of” a list of items refers to any combination of those items, including single members. For example, “at least one of: a, b, or c” is intended to cover the possibilities of a only, b only, c only, a combination of a and b, a combination of a and c, a combination of b and c, and a combination of a and b and c. As used herein, “based on” is intended to be interpreted in the inclusive sense, unless otherwise explicitly indicated. For example, “based on” may be used interchangeably with “based at least in part on,” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, components, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, components, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A wireless communication device, comprising:
at least one memory; and
at least one processor communicatively coupled with the at least one memory, the at least one processor operable to cause the wireless communication device to:
receive, via a first wireless communication link, one or more first packets carrying power management information indicating whether a first wireless station (STA) is in an awake state or a power save mode on the first wireless communication link; and
provision one or more resources for communication with the first STA in accordance with a first link residency metric (LRM) associated with the power management information carried in the one or more first packets and indicating an average amount of time the first STA is in the awake state on the first wireless communication link.

2. The wireless communication device of claim 1, wherein the at least one processor is further operable to cause the wireless communication device to:
measure a duration of each interval that the first STA is in the awake state on the first wireless communication link during a first observation period in accordance with the power management information carried in the one or more first packets; and
determine the first LRM as a sum of the duration of each interval that the first STA is in the awake state on the first wireless communication link during the first observation period divided by a duration of the first observation period.

3. The wireless communication device of claim 2, wherein the at least one processor is further operable to cause the wireless communication device to:
receive, via the first wireless communication link, one or more second packets carrying power management information indicating whether the first STA is in the awake state or the power save mode on the first wireless communication link;
measure a duration of each interval that the first STA is in the awake state on the first wireless communication link during a second observation period in accordance with the power management information carried in the one or more second packets; and
determine a second LRM as a sum of the duration of each interval that the first STA is in the awake state on the first wireless communication link during the second observation period divided by a duration of the second observation period.

4. The wireless communication device of claim 3, wherein the duration of the first observation period is different than the duration of the second observation period.

5. The wireless communication device of claim 3, wherein the provisioning of the one or more resources is further in accordance with a moving average associated with the first LRM and the second LRM.

6. The wireless communication device of claim 1, wherein, to provision the one or more resources, the at least one processor is further operable to cause the wireless communication device to:
buffer data for transmission to the first STA in a local memory in accordance with the first LRM being greater than a threshold value, the local memory being disposed on a chip that includes physical layer (PHY) hardware associated with the transmission of the data; and
buffer the data for transmission to the first STA in a remote memory in accordance with the first LRM being less than or equal to the threshold value, the remote memory being external to the chip that includes the PHY hardware.

7. The wireless communication device of claim 6, wherein the at least one processor is further operable to cause the wireless communication device to:
receive, from a network controller, control information indicating the threshold value.

8. The wireless communication device of claim 1, wherein the at least one processor is further operable to cause the wireless communication device to:
receive, via a second wireless communication link, one or more second packets carrying power management information indicating whether the first STA is in the awake state or the power save mode on the second wireless communication link, the provisioning of the one or more resources being further in accordance with a second LRM associated with the power management information carried in the one or more second packets and indicating an average amount of time the first STA is in the awake state on the second wireless communication link.

9. The wireless communication device of claim 8, wherein, to provision the one or more resources, the at least one processor is further operable to cause the wireless communication device to:
map the communication to the first wireless communication link, in lieu of the second wireless communication link, in accordance with the first LRM being greater than the second LRM by a threshold amount, the first wireless communication link and the second wireless communication link representing a primary link and a secondary link, respectively, associated with a multi-link communication with the first STA.

10. The wireless communication device of claim 9, wherein the at least one processor is further operable to cause the wireless communication device to:
receive, from a network controller, control information indicating the threshold amount.

11. The wireless communication device of claim 8, wherein, to provision the one or more resources, the at least one processor is further operable to cause the wireless communication device to:
obtain a first received signal strength indication (RSSI) associated with the first wireless communication link;
obtain a second RSSI associated with the second wireless communication link; and
steer the communication to a neighboring access point (AP) in accordance with a first weighted RSSI and a second weighted RSSI being greater than a combined RSSI threshold, the first weighted RSSI being equal to the first RSSI multiplied by a weighting factor associated with the first LRM and the second weighted RSSI being equal to the second RSSI multiplied by a weighting factor associated with the second LRM.

12. The wireless communication device of claim 11, wherein the at least one processor is further operable to cause the wireless communication device to:
receive, from a network controller, control information indicating the weighting factor associated with the first LRM and the weighting factor associated with the second LRM.

13. The wireless communication device of claim 1, wherein the at least one processor is further operable to cause the wireless communication device to:
receive, via the first wireless communication link, one or more second packets carrying power management information indicating whether a second STA is in an awake state or a power save mode on the first wireless communication link, the provisioning of the one or more resources being further in accordance with a second LRM associated with the power management information carried in the one or more second packets and indicating an average amount of time the second STA is in the awake state on the first wireless communication link.

14. The wireless communication device of claim 13, wherein, to provision the one or more resources, the at least one processor is further operable to cause the wireless communication device to:
provision a first spatial stream to the first STA and a second spatial stream to the second STA in accordance with each of the first LRM and the second LRM being greater than a threshold value, the first spatial stream and the second spatial stream being provisioned for concurrent communication with a multi-user (MU) multiple-input multiple-output (MIMO) group.

15. The wireless communication device of claim 14, wherein the at least one processor is further operable to cause the wireless communication device to:
receive, from a network controller, control information indicating the threshold value.

16. The wireless communication device of claim 14, wherein the provisioning of the one or more resources is further in accordance with a time coherency metric (TCM) associated with the power management information carried in the one or more first packets and the power management information carried in the one or more second packets, the TCM indicating an average amount of time the first STA and the second STA are concurrently in the awake state on the first wireless communication link.

17. The wireless communication device of claim 16, wherein the provisioning of the first spatial stream and the second spatial stream is further in accordance with the TCM being greater than a threshold TCM value.

18. The wireless communication device of claim 17, wherein the at least one processor is further operable to cause the wireless communication device to:
receive, from a network controller, control information indicating the threshold TCM value.

19. The wireless communication device of claim 13, wherein, to provision the one or more resources, the at least one processor is further operable to cause the wireless communication device to:
provision a greater number of scheduling grants for the communication with the first STA than for communication with the second STA in accordance with the first LRM being less than the second LRM, the communication with the first STA being associated with a same service-level agreement (SLA) service class as the communication with the second STA.

20. The wireless communication device of claim 13, wherein, to provision the one or more resources, the at least one processor is further operable to cause the wireless communication device to:
provision a number (N) of frame buffers to store data for transmission to the first STA; and
provision a number (M) of frame buffers to store data for transmission to the second STA, where N>M in accordance with the first LRM being greater than the second LRM.

21. The wireless communication device of claim 20, wherein the at least one processor is further operable to cause the wireless communication device to:
receive, from a network controller, control information indicating N and M.

22. The wireless communication device of claim 13, wherein, to provision the one or more resources, the at least one processor is further operable to cause the wireless communication device to:
map data associated with a first flow priority to a first packet queue for transmission to the first STA;
map data associated with a second flow priority to a second packet queue for transmission to the second STA; and
remap at least some of the data associated with the first flow priority to the second packet queue in accordance with the first packet queue storing at least a threshold amount of data and the second LRM being less than or equal to the first LRM.

23. A method for wireless communication at a wireless communication device, comprising:
receiving, via a first wireless communication link, one or more first packets carrying power management information indicating whether a first wireless station (STA) is in an awake state or a power save mode on the first wireless communication link; and
provisioning one or more resources for communication with the first STA in accordance with a first link residency metric (LRM) associated with the power management information carried in the one or more first packets and indicating an average amount of time the first STA is in the awake state on the first wireless communication link.

24. The method of claim 23, wherein the one or more resources include time, frequency, multi-user streams, memory, buffers, or processing resources.

25. A wireless communication device comprising:
at least one memory; and
at least one processor communicatively coupled with the at least one memory, the at least one processor operable to cause the wireless communication device to:
receive one or more first packets carrying power management information indicating whether a first STA is in an awake state or a power save mode;
receive one or more second packets carrying power management information indicating whether a second STA is in an awake state or a power save mode; and
provision one or more resources for communication with the first STA and the second STA in accordance with a time coherency metric (TCM) associated with the power management information carried in the one or more first packets and the power management information carried in the one or more second packets, the TCM indicating an average amount of time the first STA and the second STA are concurrently in the awake state.

26. The wireless communication device of claim 25, wherein the at least one processor is further operable to cause the wireless communication device to:
measure a duration of each interval that the first STA and the second STA are concurrently in the awake state during an observation period in accordance with the power management information carried in the one or more first packets and the power management information carried in the one or more second packets; and
determine the TCM as a sum of the duration of each interval that the first STA and the second STA are concurrently in the awake state during the observation period divided by a duration of the observation period.

27. The wireless communication device of claim 25, wherein, to provision the one or more resources, the at least one processor is further operable to cause the wireless communication device to:
provision a first spatial stream to the first STA and a second spatial stream to the second STA in accordance with the TCM being greater than a threshold value, the first spatial stream and the second spatial stream being provisioned for concurrent communication with a multi-user (MU) multiple-input multiple-output (MIMO) group.

28. The wireless communication device of claim 27, wherein the at least one processor is further operable to cause the wireless communication device to:
receive, from a network controller, control information indicating the threshold value.

29. A method for wireless communication by a wireless communication device, comprising:
receiving one or more first packets carrying power management information indicating whether a first STA is in an awake state or a power save mode;
receiving one or more second packets carrying power management information indicating whether a second STA is in an awake state or a power save mode; and
provisioning one or more resources for communication with the first STA and the second STA in accordance with a time coherency metric (TCM) associated with the power management information carried in the one or more first packets and the power management information carried in the one or more second packets, the TCM indicating an average amount of time the first STA and the second STA are concurrently in the awake state.

30. The wireless communication device of claim 29, wherein the one or more resources include time, frequency, multi-user streams, memory, buffers, or processing resources.
